(19) United States
(12) Patent Application Publication
(10) Pub. No.: US 2017/0036189 A1
(43) Pub. Date: Feb. 9, 2017

(54) Composite Absorbent Particles for Drying an Emulsions

(71) Applicant: Chenguang LIANG, Gatineau, CA (US)

(72) Inventor: Chenguang LIANG, Gatineau, CA (US)

(21) Appl. No.: 15/185,924

(22) Filed: Jun. 17, 2016

(30) Foreign Application Priority Data
Jun. 19, 2015 (CA) 2894692

(51) Int. Cl. B01J 20/24; B01J 20/28; C10G 33/04; C08J 3/12

(52) U.S. Cl. CPC B01J 20/24; C08J 3/126; B01J 20/28016; C10G 33/04; C08J 2301/28; C08J 2401/28

(57) ABSTRACT

Emulsions are dispersed systems wherein one phase is dispersed in another immiscible phase. Stabilized emulsions with small droplets are typically slow to phase separate and require elevated demulsifier dosage to counteract the stabilizing effect of surfactants, fine bi-wetting particles, or both; and promote droplet coalescence. The compositions and processes of the present invention are useful in removing stabilized water droplets from an emulsion with non-aqueous continuous phase. The composite absorbent particle is ideally suited to removed emulsified water through absorption of emulsified water.

### CROSS-REFERENCE TO RELATED APPLICATIONS

Not Applicable.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Dewatering Bitumen Emulsions Using Interfacially Active Organic Composite Absorbent Particles. Energy Fuels. DOI: 10.1021/acs.energyfuels.6b00228

Synthesis of Interfacially-Active Organic Micron Size Composite Particles by Dehydration of Water-in-Oil Emulsions. ACS Appl. Mater. Interfaces, 2015, 7 (37), pp 20631-20639. DOI: 10.1021/acsam i.5b05093

### BACKGROUND OF THE INVENTION

Technical Field

The composition and processes of the present invention have broad applicability in drying emulsions with non-aqueous continuous phase. The composite absorbent particles of the invention are useful in absorbing emulsified water. Accordingly, the present invention provides new compositions and processes useful in drying an emulsion. The composition and processes of the present invention have broad applicability in separation of emulsified water by absorption. The composite absorbent particles are useful in the rapid removal of water droplets from emulsions stabilized by surfactant, fine bi-wetting particles, or both; as encountered, for example, in petroleum production.

Background Art

WO 2001093977 describes a process for removing water from an emulsion comprising water and lipophilic fluid comprising exposing said emulsion to an absorbent matrix characterized by an absorbent material in order to effect the removal of said water from said lipophilic fluid and water emulsion such that the lipophilic fluid is recovered as collected lipophilic fluid.

WO 2002051518 describes a method wherein water is separated from an emulsion of water and oil by passing the emulsion through a bed of super absorbent polymer granules which break the emulsion and absorb water from the mixture of water and oil. An apparatus for separating water from an emulsion of water and oil has at least one separation cell containing a bed of super absorbent polymer granules.

EP 0072569 describes a water absorbing composite comprises an inorganic powder, and a highly absorbent resin covering the whole surfaces of the individual particles of the inorganic powder. The resin is obtained by reacting with a basic substance a polymer containing as a monomeric constituent an a, p-unsaturated compound having in its molecule one or two carboxyl groups, or one or two other groups convertible to a carboxyl group or groups, and by crosslinking the reaction product with a polyamine. The composite is useful as a water retaining agent for agriculture and horticulture, or as a dehydrating agent for oil.

WO 2000035562 describes novel compositions of drying agents of superabsorbent polymers, molecular sieves and mixtures thereof and binders of polyurethane foam, polyisocyanurate foam and supports comprising cellulose and a method for separating, drying and/or filtering chemical mixtures. The composition and method of the invention have broad applicability. They may be used, for example, to remove water from chemical mixtures like refrigerants (e.g. in vehicular refrigeration systems), air (e.g. in vehicular braking systems), natural gas and cleaning solvents (e.g. used in semiconductor manufacture and pipeline cleaning).

WO 2001093977 teaches the use of absorbent polymers including polyacrylate and polyacrylamide in the process for removing water from non-aqueous fluid used for cleaning sebum from soiled garments. WO 2001093977 specifically mentions the use of surface-crosslinked polymers, the use of spacer material, and impregnating of a film or membrane with the absorbent. WO 2002051518 teaches the use of a bed of superabsorbent polymer granules to remove water from oil. WO 2002051518 specifically suggests agitation of absorbent granules in order to fluidize the superabsorbent polymer bed. EP 0072569 describes a composite material wherein an inorganic powder is covered with an absorbent material in order to improve its durability and heat-resistance. WO 2000035562 teaches the use cellulose as a binder for molecular sieves.

### BRIEF SUMMARY OF THE INVENTION

The present invention relates to facilitating the removal of emulsified water droplets which are advantageous and addresses the shortcomings of contemporary absorbents for use in drying an emulsion. The composition and method of the present invention have applicability in drying emulsions. The composite absorbent particles described in the present invention are useful separation of emulsified water droplets from emulsions stabilized by surfactant, fine bi-wetting particles, or both, with a non-aqueous continuous phase; as encountered, for example, in petroleum production.

The present invention provides a composition for drying an emulsion which comprises an absorbent material and an interfacially active material wherein the absorbent material and the interfacially active material together form individual composite absorbent particles. The composite absorbent particles of the present invention are obtained by dehydrating emulsified droplets comprising absorbent material stabilized in a solution comprising interfacially active material by distillation, wherein the dispersed phase and the continuous phases are capable of forming a heterogeneous azeotrope.

WO 2001093977 and WO 2002051518 describe a method of separation emulsified water using a matrix or bed of absorbent polymer. The emulsified water is absorbed by material with absorbent properties as the emulsion is forced through a stationary absorbent.

Methods based on passing a large amount of non-aqueous fluid through a packed column experience high pressure drop across the packed column. Excessive pore pressure may develop when using tightly packed columns. Because water absorbents are usually very hydrophilic they suffer from poor compatibility in non-polar solvents. It is therefore difficult to dispersed hydrophilic absorbent particles in an emulsion with a continuous phase which is hydrophobic such as in a petroleum emulsion, a bitumen emulsion, or a diluted-bitumen emulsion.

The present invention relates to a composition for drying an emulsion comprising an absorbent material and an interfacially active material wherein the absorbent material and the interfacially active material together form individual composite absorbent particle. In one aspect of the present invention, the emulsion comprises a non-polar continuous phase. In another aspect of the present invention, the emulsion is stabilized by surfactant, fine bi-wetting particles, or both. In a further aspect of the present invention, the continuous phase of the emulsion is non-aqueous such as a petroleum emulsion, a bitumen emulsion, bitumen froth, diluted bitumen froth, or invert drilling fluid.

The present invention relates to composite absorbent particles formed by the absorbent material and the interfacially active material. The properties of the composite absorbent particles of the present invention, comprising the absorbent material and the interfacially active material, are ideally suited for drying an emulsion. Water-absorbing materials are typically very hydrophilic. However, hydrophilic materials have limited compatibility with organic solvents. Therefore, particles of water-absorbing materials do not disperse readily in non-aqueous phases and are not ideally suited for use in emulsions wherein target water droplets are dispersed in a non-aqueous continuous phase and stabilized by various materials. In one aspect of the present invention, the interfacially active material substantially covers the surface of the composite absorbent particle. It is important that the surface of the composite absorbent particles does not impede water from being absorbed by the absorbent material. In another aspect of the present invention, the surface of the composite absorbent particle is water-permeable.

A suitable coating of interfacially active material is necessary to ameliorate the performance of the absorbent material in non-aqueous phase. In one aspect of the present invention, the absorbent material is coated by the interfacially active material. In another aspect of the present invention, the composite absorbent particle is capable of absorbing emulsified water. In another aspect of the present invention, the composite absorbent particle is capable of absorbing more than two times its mass of water from water droplets of the emulsion.

The size of composite absorbent particles is an important aspect. Absorption is a mass transfer process and potential flux is much greater for particles with large specific surface area. Therefore, the absorption process is much faster for microscopic particles with greater specific surface area and resulting flux. The diameter of emulsion droplets generally exceeds 0.1 micrometers but may be larger than 100 micrometers. Collision efficiency is greater for droplets and particles of similar size. In one aspect of the present invention, the individual composite absorbent particles are lesser than 1000 micrometers before absorbing water. Very small absorbent particles are not effective as absorbent are they are more readily entrained in the fluid. When a small particle approaches a large particle, the flow field around the large particle will divert flow as to avoid a collision. The impact efficiency is greater for particles and droplets of roughly the same size. In another aspect of the present invention, the individual composite absorbent particles are greater than 0.5 micrometers before absorbing water.

Absorption of emulsified water requires physical contact between an emulsion droplet and the composite absorbent particle. In order to increase the probability of contact between an emulsion droplet and the composite absorbent particle, the surface of composite absorbent particles must have suitable wettability in order to remain dispersed in non-polar solvent. In one aspect of present invention, the composite absorbent particles before absorbing water are of intermediate wettability. In another aspect of present invention, the composite absorbent particles before absorbing water are capable of being dispersed in a non-polar solvent. In a further aspect of present invention, the non-polar solvent is the continuous phase of the emulsion or is miscible with the continuous phase of the emulsion.

Separation of microscopic particles is much more difficult compared to macroscopic particles which can be filtered without generating high pressure or requiring special membranes. In one aspect of the present invention, the composite absorbent particles are responsive to water absorption. A change induced by absorbing water changes the behaviour of the particles to benefit separation. The volume of a sphere is tripled when the surface area of a sphere is doubled. The surface of composite absorbent particles is in contact with water during absorption; the adsorption of water on the surface of composite absorbent particles renders the surface of the composite absorbent particle more hydrophilic due to the presence of water. As the composite absorbent particles of the present invention absorb water, the composite absorbent particles increase in volume. The change in volume decreases surface coverage of interfacial material.

After absorbing emulsified water, the composite absorbent particles experience a change in wettability, becoming more hydrophilic. The change in wettability induces aggregation of composite absorbent particles in non-polar solvent. In one aspect of the present invention, the composite absorbent particles, after absorbing water, are hydrophilic. In another aspect of the present invention, the composite absorbent particles, after absorbing water, form aggregates in a non-polar solvent. In yet another aspect of the present emulsion, the non-polar solvent is the continuous phase of the emulsion or is miscible with the continuous phase of the emulsion.

The formation of large aggregates of composite absorbent particles after absorbing emulsified water greatly facilitates separation. In one aspect of the present invention, the composite absorbent particles after absorbing water form aggregates greater than 1 millimeter in a non-polar solvent. In another aspect of the present invention, the aggregates of composite absorbent particles are separated from the non-polar solvent using a screen or filter. In yet another aspect of the present invention, the non-polar solvent is the continuous phase of the emulsion or is miscible with the continuous phase of the emulsion.

The present invention relates to a composition which is responsive. In one aspect of the invention, the surface of composite absorbent particles is in a first state before absorbing water; and the surface of composite absorbent particles is in a second state after absorbing water. In another aspect of the present invention, the composite absorbent particles disperse in a non-polar solvent in the first state; and the composite absorbent particles aggregate in the non-aqueous solvent in the second state. In yet another aspect of the present invention, the non-polar solvent is the continuous phase of the emulsion or is miscible with the continuous phase of the emulsion. In yet another aspect of the present invention, the composite absorbent particles are of intermediate wettability in the first state and the composite absorbent particles are hydrophilic in the second state. In certain embodiments of the present invention, the contact angle of the composite absorbent particles is between 70° and 110° in the first state and the contact angle of the composite absorbent particles is between 0° and 70° in the second state.

The structure of the composite absorbent particles combines advantageous the properties of different materials. The absorbent material provides sufficient absorbency to the composite absorbent particles to absorb emulsified water. In certain embodiments of the present invention, the absorbent material comprises: cellulose, carboxymethyl cellulose fibres, sodium carboxymethyl cellulose, potassium carboxymethyl cellulose, poly(acrylic acid) salts, starch, grafted starch absorbents, hydrolyzed polyacrylonitrile, poly(vinyl alcohol-sodium acrylate), and poly(isobutylene-co-disodium maleate). In another embodiment of the present invention, the absorbent material comprises: cellulose, carboxymethyl cellulose fibres, sodium carboxymethyl cellulose, and potassium carboxymethyl cellulose. In a preferred embodiment of the present invention, the absorbent material comprises sodium carboxymethyl cellulose.

The interfacially active material provides superior compatibility with the non-aqueous continuous phase of the emulsion. The interfacially active material also provides a surface which can actively displace materials which are stabilizing the emulsified droplets. In certain embodiments of the present invention, the interfacially active material comprises an emulsifier which stabilizes an emulsion with non-aqueous continuous phase. In another embodiment of the present invention, the interfacially active material comprises: ethylcellulose, methylcellulose, and hydroxypropyl cellulose. In a preferred embodiment of the present invention, the interfacially active material comprises ethylcellulose.

Magnetic separation of composite absorbent particles is possible by incorporating magnetic material in the composite absorbent particles. In certain embodiments of the present invention, the composite absorbent particles further comprise a magnetic material. In other embodiments of the present invention, the magnetic material comprises: Fe₃O₄ nanoparticles, γ-Fe₂O₃ nanoparticles, magnetite, hematite, maghemite, jacobsite, and iron. In a preferred embodiment of the present invention, the magnetic material comprises Fe₃O₄ nanoparticles.

The present invention relates to a process for preparing composite absorbent particles comprising: the step of preparing an aqueous phase comprising the absorbent material, the step of preparing a non-aqueous phase comprising the interfacially active material, the step of emulsifying the aqueous phase and the non-aqueous phase into a precursor emulsion, and the step of dehydrating the precursor emulsion; wherein the aqueous phase is the dispersed phase of the precursor emulsion and the non-aqueous phase of the emulsion is the continuous phase of the precursor emulsion. In certain embodiments of the present invention, the non-aqueous phase and aqueous phase together form a heterogeneous azeotrope and the step of dehydrating the precursor emulsion is by evaporation of the heterogeneous azeotrope.

During emulsification of the aqueous phase and non-aqueous phase into the precursor emulsion, hydrophilic materials such as the absorbent material remain in the discontinuous phase within dispersed droplets while the interfacially active material remain in the continuous phase stabilizing the dispersed droplets. The composite absorbent particles are formed by removing the water from dispersed droplets. After removing the water from the precursor emulsion, the interfacially active material substantially covers the surface of the composite absorbent particles. After removing the water from the precursor emulsion, the absorbent material is coated by the interfacially active material.

In certain embodiments of the present invention, the aqueous phase comprises water and the non-aqueous phase comprises: benzene, benzene/ethanol, benzene/isoproapanol, benzene/allyl alcohol, benzene/methyl ethyl ketone, toluene, toluene/ethanol, heptane, heptane/ethanol, cyclohexane, ethyl acetate, butyl acetate, chloroform, chloroform/methanol, carbon tetrachloride, carbon tetrachloride/methyl ethyl ketone, methylene chloride, or butanol. The properties of the precursor emulsion can be modified by adding surfactant or a viscosity modifier. In other embodiments of the present invention, the non-aqueous phase further comprises a surfactant and a viscosity modifier. A salt dissolved in the aqueous phase will precipitate into a solid once water is removed. Fine solids with hydrophilic surface will remain dispersed in the aqueous phase. In other embodiments of the present invention, the aqueous phase further comprises a dissolved salt, a surfactant, a viscosity modifier, and a finely dispersed solid. Addition can increase the specific gravity of the particle. In yet embodiment of the present invention, the dissolved salt comprises sodium chloride, potassium chloride and the finely dispersed solid comprises iron oxide and barium sulphate. In yet another embodiment of the present invention, the process for preparing composite absorbent particles further comprises the step of chemical crosslinking or thermal crosslinking.

The present invention relates to a process for removing emulsified water from an emulsion comprising: the step of adding of the composition of composite absorbent particles to the emulsion, the step of providing sufficient agitation and time for absorption the emulsified water by the composite absorbent particles; and the step of separating the composite absorbent particles after absorption of water. Due to its unique combinations of properties, the composition of the present invention may be added to the emulsion. The interfacial properties of composite absorbent particles allow them to have sufficient mobility in the continuous phase of the emulsion in order to reach emulsified droplets, remain attached on the interface, and allow absorption of emulsified water. The absorption of emulsified water is a mass transfer process wherein composite absorbent particles much first make contact with emulsified water droplet and remain in contact for a sufficient amount time to allow absorption of emulsified water. Absorption of emulsified water is complete after providing sufficient agitation for composite absorbent particles to contact emulsified droplets and after providing sufficient time for composite absorbent particles to absorb emulsified water. Removing emulsified water from an emulsion is complete after separation of the composite absorbent particles after absorption of water.

Again due to the unique combinations of properties, the composition of the present invention undergoes a change from one state to a second state upon absorbing water. Although, in the first state, composite absorbent particles are dispersed in non-polar solvent, in the second state, composite particles form large aggregates. These large aggregates of hydrated composite absorbent particles are easily removed using a simple screen. In one embodiment of the present invention, the step of separating the composite absorbent particles after absorbing water comprises filtration. Composite magnetic particles, impregnated with magnetic material, are separated under an applied magnetic field. In another embodiment of the present invention, the step of separating the composite absorbent particles after absorbing water comprises filtration.

It is beneficial to provide composite absorbent particles in the form of a dispersion of solids in a non-polar solvent. The present invention relates to a dispersion comprising of composite absorbent particles and a non-aqueous dispersant medium. In certain embodiments of the present invention, the non-aqueous dispersant medium comprises methanol, ethanol, propanol, n-butanol, iso-butanol, chloroform, carbon tetrachloride, methylene chloride, ethyl acetate, butyl acetate, benzene, toluene, and cyclohexane. In yet another embodiment of the present invention, the dispersion further comprises a surfactant, a wetting agent, a dispersing agent, and a viscosity modifying agent.

### BRIEF SUMMARY OF THE DRAWINGS

The drawings provided in FIG. 1-15 are illustrative of one or more embodiments of the invention, as specified in its description.

FIG. 1 is a scanning electron micrograph of composite absorbent particles, prepared according to Example 1;

FIG. 2 is a Fourier-transform infrared absorption spectra of composite absorbent particles, prepared according to Example 1;

FIG. 3 is a thermogravimetric analysis curve of composite absorbent particles, prepared according to Example 1;

FIG. 4 is an image of EC, CMC, and composite absorbent particles (CMC/EC), prepared according to Example 1, in a biphasic mixture of toluene and water;

FIG. 5 is an image of composite absorbent particles, prepared according to Example 1, in toluene before absorbing water [LEFT] and after [RIGHT] absorbing water;

FIG. 6 is a plot of particle size distribution and cumulative distribution for various composite absorbent particle samples, prepared according to Example 4 using different EC-concentration in the non-aqueous phase;

FIG. 7 is a SEM micrograph of composite absorbent particles, prepared according to Example 5;

FIG. 8 is a plot of particle size distribution and cumulative distribution for composite absorbent particles, prepared according to Example 5 with continuous sonication during emulsion dehydration;

FIG. 9 is a transmission electron micrograph of magnetic composite absorbent particles, prepared according to Example 8, showing iron oxide nanoparticle within magnetic composite absorbent particles;

FIG. 10 is an image of magnetic composite absorbent particles, prepared according to Example 8, in toluene in the absence of a magnetic field [LEFT] and in the presence of a permanent magnet [RIGHT];

FIG. 11 is a series of micrographs of a stabilized water-in-mineral oil emulsion, prepared and treated according to Example 10, with either magnetic composite absorbent particles [RIGHT] or non-magnetic composite absorbent particles [MIDDLE] or left untreated [LEFT].

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

The term “emulsion”, as used herein, refers to a mixture of two or more immiscible phases wherein small droplets of one phases is dispersed (i.e. non-continuous phase) into an immiscible phase (i.e. the continuous phase). The term emulsion may include an emulsion with a continuous phase which is aqueous or may include an emulsion with a continuous phase which is non-aqueous. Non-limiting examples of emulsion the continuous phase of is non-aqueous include petroleum emulsion, bitumen emulsion, bitumen froth, diluted bitumen froth, or invert drilling fluid.

The term “aqueous phase”, as used herein, indicates a liquid phase which comprises sufficient polar solvent or water such that its physiochemical properties are similar to water and is immiscible with a non-aqueous phase. The term non-aqueous phase, as used herein, indicates a liquid phase which comprises sufficient non-polar solvent such that its physiochemical properties are dissimilar to water and is immiscible with an aqueous phase.

The term “polymer”, as used herein, refers to a material with repeating subunits. The term polymer may refer to a homopolymer, a copolymer consisting of two or more components, or mixtures thereof; having molecular weight typically from 1 000 000 g/mol to 100 000 000 g/mol.

The term “cellulose”, as used herein, refers to a long-chain polysaccharide comprised of R-glucose monomer units of formula (C₆H₁₀O₅)ₙ. Cellulose is a polymer produced from natural sources including cotton fibre, wood pulp, hemp, and other plants. Cellulose obtained from wood pulp and cotton fibre may be subsequently processed into chemical derivatives with drastically different properties. The hydroxyl groups (—OH) are particularly susceptible to chemical transformations. The final properties of a cellulose derivative are functions of both the nature of the substituting group and the degree of substitution.

The term “size”, as used herein in reference to emulsion droplets and composite absorbent particles, is the diameter, observed directly through microscopy or inferred by their motion, measured by light scattering. The term size, as used herein in reference to irregular shaped particles, refers to the length of the particles across an arbitrary axis. The term fine, as used herein reference to droplets, solids, and particles, refers to droplets, solids, and particles which are sufficiently small for the effect of gravity to be negligible; typically less than 100 micrometers.

The stability of many emulsions, especially those encountered during petroleum production, may be the result of indigenous materials. Many substances derived from nature such as petroleum contain natural surface active materials. Furthermore, many process additives can provide additional stabilizing effect. Physiochemical changes encountered during processing, including changes to solvent polarity, pH, and ionic strength, can activate stabilizing materials including fine bi-wetting particles.

Numerous methods have been developed in order to facilitate removal of dispersed droplets as it is often undesirable in a process to have a mixture consisting of multiple phases. Furthermore, certain unit operations cannot tolerate certain phases. Rapid removal of emulsified droplets can be especially difficult for small stabilized droplets. Stable emulsions are characterized by prolonged phase separation which can last from several hours to several years. Phase separation generally occurs through various processes: flocculation, sedimentation or creaming, coalescence, and Ostwald ripening. In many industrial processes, emulsion phase separation must be accelerated using chemical methods, physical methods, or combinations thereof.

Incompatible phases such as oil (i.e. non polar) and water (i.e. polar) are immiscible. However, given sufficient energy, one phase may be effectively dispersed into the other, forming many small droplets of the discontinuous phase within the continuous phase. Therefore, an emulsion consists of at least one continuous phase and one discontinuous phase. The emulsification process requires sufficient energy to generate the new interfacial area corresponding to the much smaller droplets produced. Without continuous agitation, the two immiscible phases of an emulsion will begin to phase separate through sedimentation, coalescence, and Ostwald ripening. Phase separation can be retarded with addition or activation of stabilizers. Generally, emulsions with well-stabilized droplets less than 10 micrometers are slow to separate. Stable emulsions often require additional chemical or physical processing to accelerate phase separation. The process of breaking an emulsion by accelerating phase separation is known as demulsification.

Emulsions are stabilized by surfactants which are compounds with partial or limited compatibility with both the continuous phase and the discontinuous phase. The chemical structure of a surfactant typically contains at least one portion which is more hydrophilic and at least one portion which is more lipophilic. The hydrophilic moiety of a surfactant typically comprises ionic functional groups, hydrogen-bonding functional groups, and functional groups with strong dipole moment. The lipophilic moiety of a surfactant is usually uncharged. Due to their amphiphilic structure and limited compatibility with both polar and non-polar solvents, surfactant molecules preferentially absorb onto the interface. Thus, surfactants lower the interfacial energy of an emulsion and provide increased emulsion stability.

Emulsions are also stabilized by fine bi-wetting particles which irreversibly absorb onto the interface between the continuous phase and the discontinuous phase. Large macroscopic particles cannot stabilize an emulsion due to immediate sedimentation under gravity. Fine particles, on the other hand, can remain dispersed in a solution. The equilibrium position of a particle absorbed onto the interface is determined by its shape, size, and surface properties. The contact angle of a material formed by a liquid such as water provides an indication of its wettability. A low contact angle with respect to water indicates that the surface is mostly wetted by an aqueous phase while an elevated contact angle with respect to water indicates that the surface is mostly wetted by an organic phase.

Different types of emulsions can be made including water-in-oil (W/O), oil-in-water (O/W), and even complex multiple emulsions wherein droplets are dispersed within dispersed droplets; that is, oil-in-water-in-oil (O/W/O) or water-in-oil-in water (W/O/W). The bulk properties of an emulsion, especially dilute emulsions, such as viscosity and conductivity, more often resemble those of the continuous phase. The relative solubility of a surfactant provides an indication of the type of emulsion which can be stabilized. Surfactants with more lipophilic character are more soluble in non-polar solvent and will preferentially stabilize an oil-continuous emulsion. In contrast, surfactants with more hydrophilic character are more soluble in polar solvent such as water and will preferentially stabilize a water-continuous emulsion.

For particle-stabilized emulsions, hydrophilic particles preferentially stabilize emulsions with a polar continuous phase such as water while hydrophobic particles preferentially stabilize emulsions with a non-polar continuous phase such as oil. For homogeneous particles of given shape and size, the stabilization energy provided by a particle is greatest when the surface is bi-wetting. The most effective stabilizer particles have a contact angle close to 90° indicating similar preference for both phases. Amphiphilic Janus particles can further increase emulsion stability due to increased absorbing energy resulting from the anisotropic surface wettability.

Flocculation occurs when droplets collide and associate together. Droplet association can range from very weak to very strong. Chemical additives known as flocculants promote formation of groups of emulsified droplets. Coalescence occurs when two or more droplets combine to make a large droplet. Sedimentation and creaming occur when there is a difference in specific gravity between the continuous phase and the discontinuous phase. The resulting buoyant force resulting from gravity is often insufficient for rapid phase separation. The rate of sedimentation and creaming can be accelerated using centrifuges. In certain systems, there is a marginal difference in density; for example, bitumen and water at ambient temperature have very similar density. The difference in density can be increased by increasing temperature.

Low-shear agitation can promote phase separation by increasing the rate of droplet collision but the energy input must be limited to prevent breaking apart flocculated droplets and avoid further emulsification. Heating the emulsion can promote phase separation by increasing the difference in density between phases, lowering the viscosity of the continuous phase, and providing additional thermal energy to colliding droplets. Diluting an emulsion can promote phase separation by lowering both the density and the viscosity of the continuous phase. In certain cases, diluting with specific solvents can cause precipitation, especially for marginally soluble material, which often includes the interfacially active compounds.

Chemical treatments are often necessary to accelerate phase separation of stable emulsion. Chemical compounds known as demulsifiers work by displacing, neutralizing, or supressing the effect of stabilizing species present at the interface. In general, surfactants which stabilize O/W type emulsions will tend to destabilize W/O emulsions. High molecular weight polymers and multivalent species can also provide additional steric bridging, electrostatic bridging, or both between droplets; thus, promoting flocculation and aggregation. In order for chemical treatments to have an effect on the stability of an emulsion, the solubility or mobility of the additive in the continuous phase of the emulsion must be sufficient in order for a chemical compound or a particle to migrate to the interface formed by emulsion droplets.

Although removing a portion of emulsified water consisting of larger emulsified droplets is usually possible, the remaining finer emulsified droplets are more difficult. Emulsion with droplets less than 10 micrometers extremely slow to separate and require combined process strategies to counteract the stabilizing effect of surfactants, fine bi-wetting particles, or both. Removing the last remaining well-stabilized water droplets is known as finishing an emulsion but often requires disproportionately high demulsifier dosage. Furthermore, many demulsifiers such as those based on copolymers of ethylene oxide and propylene oxide are prone to overdosing at high concentration. Overdosing is a phenomenon wherein increasing the concentration of the demulsifier results in greater emulsion stability and slower phase separation.

Residual water in the emulsion, found in the form of emulsified water droplets, is typically not desired. The presence of water can lead to operational problems downstream. Water droplets often contain salts which reduce the effectiveness of many refinery catalysts. During pipeline transport, emulsified water may cause additional corrosion. Certain pipeline operators prefer feeds which contain less than 0.5% basic sediment and water and may charge additional fees if a feed exceed specified limits. Removing residual water from emulsions or drying an emulsion is either required or desired in many processes.

Drying an emulsion is conventionally achieved through demulsification. During the process of demulsification, coalescence of emulsified water droplets is promoted until combined droplets are sufficiently large to be susceptible to separation by gravity settling, cyclone, or centrifuge. Chemical additives and diluents are often used to enhance the rate of droplet coalescence. Disc centrifuges are capable of separating materials down to approximately 44 micrometers. Direct filtration of emulsified water droplets is not feasible.

Alternatively, drying an emulsion can be achieved by absorbing emulsified water. Absorbents are materials which can readily soak up and hold a liquid. Various types of absorbents which can absorb several times their mass in water have been developed for use as retaining agents, blocking agents, drying agents, and for other purposes. These absorbents are commonly based on hydrophilic materials such as fibres, polymers, and other non-wovens. Important water-absorbing polymer technologies include carboxymethyl cellulose salts, poly(acrylic acid) salts, hydrolyzed polyacrylonitrile, polyacrylonitrile grafted-starch, poly(vinyl alcohol), and poly(vinyl alcohol-co-sodium acrylate).

Absorptive materials are capable of drawing in a substance when in contact and retaining the absorbed substance. There are numerous materials capable of absorbing water. Porous materials such as zeolites or materials with capillary systems such as natural sponges are effective absorbents. Natural and synthetic polymers, especially polyelectrolytes, also make excellent water absorbents but are intrinsically more sensitive to ionic strength compared to non-ionic materials.

Non-limiting examples of absorptive materials include polysaccharides, cellulose derivatives, starch derivatives, natural gum derivatives, and synthetic polymers. Specific non-limiting examples of absorptive materials made from natural derivatives include carboxymethyl cellulose salts, crosslinked starch, polyacrylonitrile grafted-starch. Non-Specific non-limiting examples of absorptive materials made of synthetic polymers include poly(acrylic acid) salts, hydrolyzed polyacrylonitrile, poly(vinyl alcohol), poly(vinyl alcohol-co-sodium acrylate), and poly(acrylamide-co-sodium acrylate).

The solubility of cellulose ether is controlled by both the nature of the substituents, the degrees of substitution, and other specific physiochemical treatments including chemical crosslinking, thermal crosslinking, radiation crosslinking, and surface crosslinking. Carboxymethyl cellulose is a cellulose ether wherein a portion of the hydroxyl groups of cellulose are substituted with carboxymethyl groups. Generally, carboxymethyl cellulose is available as a salt; the sodium salt has greater absorption capacity while the potassium absorbs water relatively faster. Typically, carboxymethyl cellulose, with a degree of substitution greater than 0.7, is soluble in water. For use as an absorbent, carboxymethyl cellulose is often prepared or treated to be at least partially insoluble; for example, by acid treatment, heat treatment, or chemical crosslinking.

Another absorbent material derived from natural polymer is the hydrolyzed product of starch-acrylonitrile co-polymer made by grafting acrylonitrile polymer onto a starch backbone. The starch-acrylonitrile co-polymer produces an effective water absorbent material.

Synthetic polymers also make effective water absorbent materials. Poly(acrylic acid) is an effective water absorbent material commonly available as an alkali metal salt such as sodium polyacrylate, potassium polyacrylate, ammonium polyacrylate, and lithium polyacrylate. Polyacrylate is an anionic polymer; copolymerization with acrylamide improves performance in high-ionic strength environment. Poly(vinyl alcohol) is non-ionic water-soluble polymer with the ability to absorb water. Copolymers of polyacrylate and poly(vinyl alcohol) are also available.

Interfacially active materials exhibit preference for the interface between two immiscible phases. Interfacially active materials include surfactants which adsorb onto a liquid-liquid interface and wetting agents which adsorb onto a solid-liquid interface. Surfactants are interfacially active molecules which have partial compatibility in both hydrophilic (i.e. polar) and lipophilic (i.e. non-polar) phases. In solution, surfactants above a characteristic critical micelle concentration will begin to self-assembly into micelles or other higher order associations. A typically structure for a surfactant comprises a hydrophilic moiety, such as an ionized acid group, and a lipophilic moiety, such as a saturated hydrocarbon chain. An ionic surfactant refers to a surfactant which contains at least one functional group with electrostatic charge such as carboxylate, sulphate, and phosphate. The term non-ionic surfactant refers to a surfactant which lacks an ionic moiety but nonetheless possesses a chemical structure with regions which are more hydrophilic and regions which are more lipophilic. Non-ionic hydrophilic function group typically contain polar functional groups such as ester, ether, and hydroxyl groups. Polymers made from monomers of contrasting properties are also interfacially active. Block copolymers of poly(ethylene oxide-co-propylene oxide) contains both regions which are more hydrophilic and more hydrophobic. Polysorbates are examples non-ionic surfactants made with a sorbitan derivative, often ethoxylated, which acts as the hydrophilic moiety. The hydrophilic-lipophilic balance, which is an empirical or calculated measure of the relative contribution of the contrasting regions of a surfactant molecule, provides appropriate usage of the surfactant.

Non-limiting examples of anionic surfactants include alkyl sulfates and sulfonates, petroleum and lignin sulfonates, phosphate esters, sulfosuccinate esters, ethoxylated acids, and carboxylates. Non-limiting examples of non-ionic surfactants include fatty alcohols, fatty amines, ethoxylated amines, ethoxylated alcohols, alkylphenol ethoxylates, fatty acid esters, amine derivatives, amide derivatives and amine oxides. Non-limiting examples of cationic surfactants include quaternary ammonium salts. Non-limiting examples of amphoteric surfactants include carboxybetaines, and sulfobetaines.

The partial or limited compatibility of a surfactant in both phases leads to a preference for the interfacial region. The presence of a surfactant at the interface may alter the interfacial tension and affect emulsion stability. Surfactants used to stabilize emulsions are known as emulsifiers while surfactants used to destabilize emulsions are known as demulsifiers. Generally, a surfactant which stabilizes O/W-type emulsions will destabilize W/O-type emulsions. Most commercial demulsifiers are complex mixtures of various surfactants and additives.

Non-limiting examples of emulsifiers include lecithins, esters of monoglycerides of fatty acids, mono- and diglycerides of fatty acids, poly(oxyethylene) stearate, polyoxyethylene sorbitan laurate, polyoxyethylene sorbitan oleate, polyoxyethylene sorbitan palm itate, polyoxyethylene sorbitan stearate, dioctyl sodium sulphosuccinate, sugarglycerides, stearyl tartrate, and stearyl citrate. Non-limiting examples of demulsifiers include phenol-formaldehyde resins, epoxy resins, polyethyleneimines, polyamines, di-epoxides, and polyols.

Fine bi-wetting solid particles are also capable of stabilizing emulsions. The equilibrium position of a small particle attached onto the interface of two immiscible phases is determined by its wettability. A water droplet formed on a hydrophilic surface will spread on the surface and result in a low contact angle. A water droplet formed on a lipophilic surface will not spread as much on the surface and result in an elevated contact angle. A surface with intermediate wettability may have a contact angle between 70° and 110°. The term bi-wetting, as used herein, refers to a surface which is wetted by both aqueous and non-aqueous liquids. Particles with bi-wetting surface are compatible with both hydrophilic and lipophilic solvents. The term bi-wetting includes materials which have surfaces with a contact angle between 70° and 110°. The most effective emulsion stabilizer particles are particles with bi-wetting surface; perfectly bi-wetting particles have a contact angle close to 90°.

Wetting agents are interfacially active materials which preferentially adsorb onto the surface of a solid and alter its original wettability. A wetting agent may adsorb onto a surface making it more hydrophilic or, alternatively, making it more hydrophobic. Wetting agents adsorb onto solid surfaces due to partial compatibility or solubility in the liquid phase or through specific interactions with the surface. Many non-ionic surfactants and polymeric surfactants function well as wetting agents. Wetting agents are also useful in promoting adhesion or to reduce friction. Non-limiting examples of wetting agents include polyols, alkoxylated polyols, poly(oxyethylene), alkylphenol ethoxylates, and monoethanolamine-dodecylbenzene sulfonates.

Specific materials have characteristic surfaces with different surface properties. When oxides are immersed in water, hydrolysis and adsorption of ions results in a solid surface with net charge. The pH of the solution can be adjusted to modify and even reverse the surface charge. The wettability of a particle can be modified through chemical reactions with the surface to install different functional groups on the surface. Alternatively, the wettability of a particle can also be modified by adsorbing a different material on its surface. A hydrophilic surface with many ionic charges may be coated by with a material lacking ionic charge to increase the surface's compatibility with non-polar solvents. Likewise, a lipophilic surface, with little surface charge, may be coated by a material with polar functional groups to increase the surface's compatibility with polar solvents.

Certain cellulose derivatives have a chemical structure which is interfacially active including cellulose modified with various non-polar groups. Cellulose is insoluble in water due to dominant intermolecular forces resulting from extensive hydrogen bonding. Reducing the number of hydroxyl group in cellulose can improve water-solubility by reducing strength of intermolecular forces between cellulose polymer chains. Accordingly, methylcellulose and hydroxypropyl under certain conditions is soluble in water. However, water-insoluble cellulose derivatives, such as ethylcellulose, are produced after substituting hydroxyl functional groups with more non-polar functional groups. Ethylcellulose is interfacially active and capable of displacing indigenous surfactants which stabilize bitumen emulsions. Non-limiting examples of interfacial active materials include ethylcellulose, methylcellulose, and hydropropyl cellulose.

Ethylcellulose is an example of a cellulose ether with a portion of the hydroxyl groups of cellulose are substituted with ethyl ether groups. Typically, ethylcellulose with ethyl content of greater than 32 wt % is soluble in non-polar solvents such as benzene, toluene, and dichloromethane. Methylcellulose is another example of a cellulose ether wherein a portion of the hydroxyl functional groups of cellulose are substituted with methoxy functional groups. Methylcellulose is soluble in cold water but not hot water with a lower critical solution temperature between 40° C. and 50° C. Commercial methylcellulose samples have degree saturation between 1.3 and 2.6. Hydroxypropyl cellulose is yet another example of a cellulose ether. Hydroxypropyl cellulose can be soluble in both aqueous and non-aqueous solutions. In addition to the hydroxyl groups on the glucose monomer which undergo chemical reaction, the hydroxypropyl functional group contains a hydroxyl group which can undergo further reactions. Therefore, it is possible to have a degree substitution exceeding 3.0; in this case, the number of moles of substitution per glucose unit can be applied. Generally, hydroxypropyl cellulose with moles of substitution greater than 4.0 possesses aqueous solubility. Hydroxypropyl cellulose also has a lower critical solution temperature, between 35° C. and 45° C. Hydroxypropyl methyl cellulose is a cellulose ether with a portion of the hydroxyl groups of cellulose are substituted with both methyl ether and hydroxypropyl ether.

Although the processes and compositions described in the present invention are described in detail, it should be understood, and one skilled in the art will recognize, that various processes and compositions capable of carrying out the invention could be used.

A composite material is made from at least two materials in order to combine or enhance their advantageous properties. The structure of a composite particle must be such that the desired properties of the different materials are effectively expressed. The method of preparing composite particles is important due to its impact on particle size and morphology. In one embodiment, the composition of the present invention is prepared according to Example 1. Using the compositions and processes described in the present invention, an emulsion is dried by absorbing emulsified water droplets with composite absorbent particles. In one embodiment of the present invention, emulsified water droplets are removed from an emulsion with non-aqueous continuous phase. In a preferred another embodiment of the present invention, the composition is suitable for drying an emulsion stabilized by surfactants, fine bi-wetting particles, or both. According to the invention, the composition for drying an emulsion comprises individual composite absorbent particles. Each individual composite absorbent particle comprises an absorbent material and an interfacially active material. The composite absorbent particles described in the present invention are suitable for drying an emulsion with non-aqueous continuous phase by absorbing emulsified water. Also according to the present invention, an absorbent material with high capacity for absorbing water is combined with an interfacially active material such that the interfacially active material imparts its beneficial surface properties onto the absorbent material. According to the invention, the composite absorbent particles each comprise a core of absorbent material and a shell of interfacially active material. The term core, as used herein, refers to the inner portion of the composite absorbent particle which is comprised of absorbent material. The term shell, as used herein, refers to the outer portion of the composite absorbent particles which is comprised of interfacially active material.

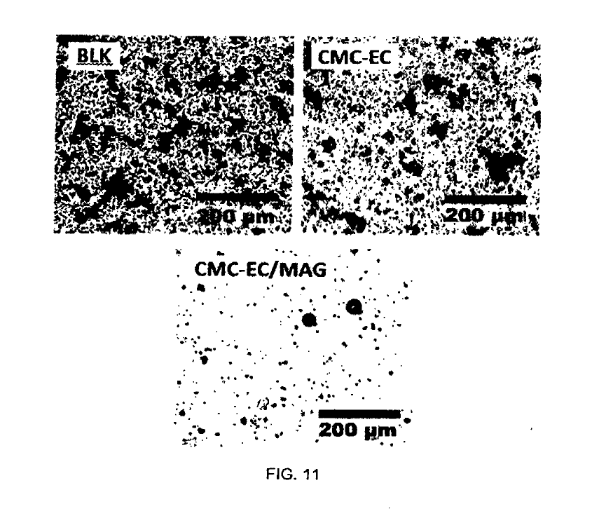

The surface of a particle is critical in determining its wettability and colloidal stability in polar or non-polar solvents. According to the invention, it is important that the interfacially active material essentially covers the surface of the composite absorbent particle in order to have effect on wettability. Composite absorbent particles, prepared according to Example 1, are spherical, as revealed in SEM image, FIG. 11. Although water-absorbent material is typically hydrophilic, after coating with interfacially active material, composite absorbent particles are more compatible in non-aqueous solvents with low polarity. Water may be absorbed by the absorbent material once composite absorbent particle contacts emulsified water droplet. Physical contact between composite absorbent particles and emulsified water droplets is necessary for drying an emulsion by absorption of emulsified water. Therefore, mobility of composite absorbent particles in the continuous phase of the emulsion is essential. Given an emulsion with a non-aqueous continuous phase, mobility of composite absorbent particles in non-polar solvent is important. Measurement of critical surface tension, according to Example 3, of the composite absorbent particles of the present invention, indicates that the particles, before absorbing water, are less hydrophilic compared to CMC. Due to the less hydrophilic surface, composite absorbent particles, prepared according to Example 1, are dispersed in non-polar solvents.

Non-limiting examples of non-polar solvents include petroleum, bitumen, crude oil, and petroleum condensate. Additional, non-limiting examples of non-polar solvents include petroleum distillation fractions such as mineral oil, fuel oil, gasoline, kerosene, diesel, paraffin, and naphtha. Other non-limiting examples of non-polar solvents include saturated hydrocarbons, unsaturated hydrocarbons, aromatic hydrocarbons, resins, and ashphaltenes. Non-limiting examples of non-polar solvents containing oxygen include fatty alcohols, fatty ketones, and fatty aldehydes.

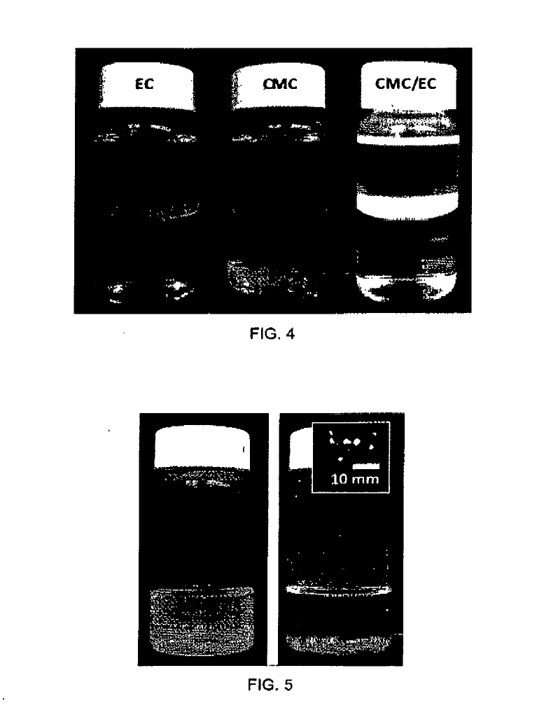

In order not to impede water absorption, the surface of the composite absorbent particle must allow water to pass through. Coating particles with very hydrophobic materials may increase contact angle but the resulting particle may possess a coating which is impermeable to water. An impermeable coating will significantly limit the ability of the absorbent particle to absorb water and negatively impacts dewatering performance. According to the present invention, the composite absorbent particles have a coating which is permeable to water. The amount of water that may be absorbed by composite absorbent particles is dependent on their composition and increases with greater CMC content. Only absorbent particles which make contact with water droplets and remain on the interface may absorb the emulsified water. Therefore, the interracially active coating accelerates water absorption and improves dewatering performance. According to the invention, the composite absorbent particles are capable of absorbing emulsified water. Fine particles with intermediate wettability preferentially attach onto the interface formed between two immiscible phases. Similarly, composite absorbent particles with intermediate wettability are capable of remaining at the interface formed by two immiscible phases such as emulsified water droplets. According to Example 2, the composite absorbent particles prepared according to Example 1 are interfacially active, adsorbing onto the interface between toluene and water, FIG. 4. Increased affinity for the interface promotes absorption of water by the composite absorbent particles.

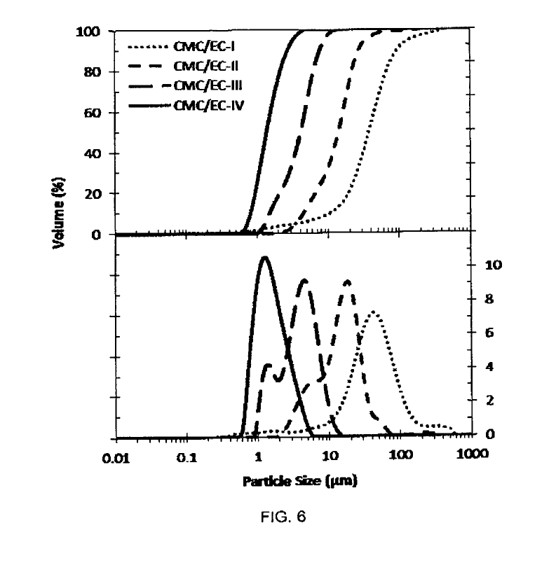

The composition of the present invention comprises composite absorbent particles which may have different properties, such as composition and particle size. The physical properties of composite absorbent particles, prepared according to Example 4 using different reaction conditions, are summarized in Table 1. By adjusting the concentration of EC in the non-aqueous phase, composite absorbent particles were prepared using the emulsion dehydration method described in the present invention. At ambient temperature, 0.5 wt % EC in toluene was sufficient to stabilize a water-in-oil emulsion. However, the emulsion prepared using 0.5 wt % EC in toluene undergoes phase separation, which is immediately evident when the emulsion is heated. The stability of a water-in-toluene emulsion can be improved by increasing surfactant concentration. Increasing concentration of either EC or CMC in their respective phases increases the viscosity of the resulting solutions. The effect of CMC and EC on viscosity is influenced by the source of the cellulose derivative and the method of manufacture. A high-viscosity continuous phase can slow phase separation by retarding movement of emulsified droplets. Composite absorbent particles, prepared according to Example 4 using CMC concentration between 0.5 and 3.0 wt % in the aqueous phase, are of similar size. Composite absorbent particles, prepared according to Example 4 using different ratios between aqueous phase and non-aqueous phase, are also of similar size. Composite absorbent particles are prepared according to Example 4 by dehydrating precursor emulsions prepared using different EC concentrations in the non-aqueous phase. Increasing EC concentration leads to precursor emulsions with greater stability and thus reduced size of composite absorbent particles after dehydration of precursor emulsion. The resulting particle size distribution of select composite absorbent particles, prepared according to Example 4 using different EC concentrations in the non-aqueous phase, is presented in FIG. 6, and decreases with greater EC concentration; ranging from 0.5 to 100 micrometers. Although composite absorbent particles, prepared according to Example 4, contain different amounts of CMC and EC, composite absorbent particles all exhibited similar critical surface tension between 26 and 28 mN/m; the modified surface wettability indicates successful surface coating by more lypophilic EC.

TABLE 1

| | | Non-Aqueous | Average Size | EC Content |
|---|---|---|---|---|
| Sample | Aqueous Phase | Phase | (μm) ^{a} | (wt %) ^{b} |
| I | 2.0 wt % CMC | 0.5 wt % EC | 76.0 | 22 |
| II | 2.0 wt % CMC | 1.0 wt % EC | 35.3 | 30 |
| III | 2.0 wt % CMC | 2.0 wt % EC | 4.0 | 38 |
| IV | 2.0 wt % CMC | 3.0 wt % EC | 1.3 | 42 |

^{a} Sauter mean diameter measured by light scattering;
^{b} EC content determined by thermogravimetric analysis.

Oilfield emulsions generally have droplet diameters that exceed 0.1 micrometer and may be larger than 100 micrometers, up to 1000 micrometers. The size of emulsion droplets can be represented by a distribution function and is related to the stability of the emulsion. Water droplets greater than 1000 micrometers typically separate quickly without requiring chemical treatment. A loose emulsion separates slowly, having droplets typically between 5 and 75 micrometers and an average droplet size of approximately 15 micrometers. A medium emulsion is more stable, having droplets typically between 5 and 30 micrometers and an average droplet size of approximately 10 micrometers. Tight emulsions have droplets typically between 1 and 20 micrometers and a large number of droplets below 10 micrometers. Tight emulsions are the most difficult to break because they contain very small well-stabilized emulsified droplets. Incorporation of water droplets and formation of emulsions during petroleum extraction cannot be prevented due to the intimate presence of water in the formation and the critical role of water or steam during recovery. The size of emulsion droplets can increase or decrease during transport and processing of crude petroleum depending on any changes to environmental conditions (e.g. temperature and pressure), exposure to high shear (e.g. pumping and turbulent flow), and chemical reactions (e.g. saponification of naphthenic acids) incurred during the process.

The composite absorbent particles of the present invention are ideally suited for drying emulsions by absorbing emulsified water. Absorption is a mass transfer process and superior water flux is possible for smaller particles with greater specific surface area. Collision events between absorbent particles and dispersed droplets are more efficient when both absorbent particles and dispersed droplets are similar in size. Absorption is optimal when composite absorbent particles and emulsified droplets are similar in size. According to the present invention, the composite absorbent particles are lesser than 1000 micrometers before absorbing water. Still according to the present invention, the composite absorbent particles are lesser than 100 micrometers before absorbing water. Still according to the present invention, the composite absorbent particles are lesser than 75 micrometers for drying loose emulsions; lesser than 50 micrometers for drying medium emulsions; and lesser than 20 micrometers for tight emulsions. The method of preparing the composition of the present invention is particularly well-suited for preparing particles which are similar in size as emulsion droplets. However, composite absorbent particles which are smaller than emulsified droplets are less than optimal for water absorption. According to the present invention, the composite absorbent particles are greater than 0.5 micrometers before absorbing water. Still according to the present invention, the composite absorbent particles are greater than 5 micrometers before absorbing water. Still according to the invention, the composite absorbent particles are greater than 50 micrometers before absorbing water.

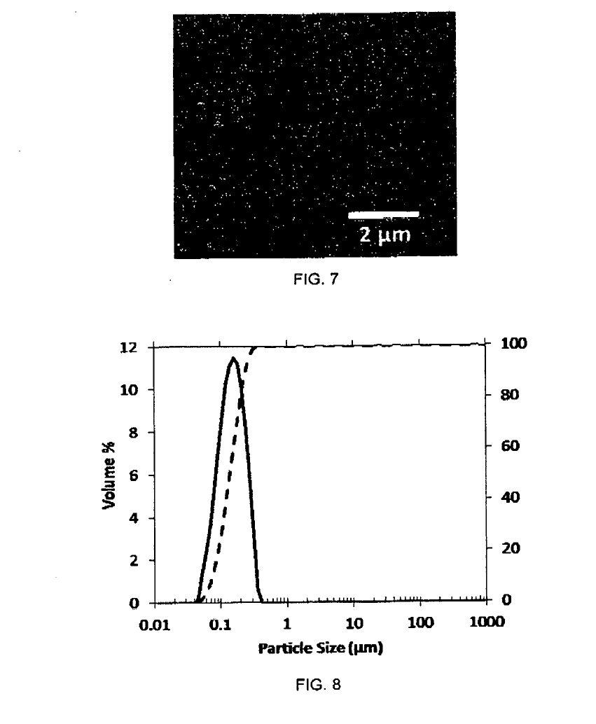

Composite absorbent particles are prepared, according to Example 5, using high EC concentration and continuous high-intensity agitation, provided by an ultrasonic dismembrator, during dehydration of precursor emulsion. Composite absorbent particles, prepared according to Example 5, are also spherical as revealed in SEM image, FIG. 7. Composite absorbent particles prepared according to Example 5 are smaller compared to composite particles prepared according to Example 1. Composite absorbent particles prepared according to Example 5 are between 50 and 300 nanometers. Surface properties begin to dominate for nano-sized composite absorbent particles, to the detriment of water absorption which requires an essential amount of water-absorbent material. According to the invention, the composite absorbent particles have the capacity to absorb at least two times its mass of water. The water absorbent properties of various composite absorbent particles are summarized in Table 2, including sample D which was prepared according to Example 5, using high EC concentration and continuous high-intensity agitation.

TABLE 2

| | EC Content | Water Absorbency | Critical Surface Tension |
|---|---|---|---|
| Sample | (wt %) | (g/g) ^{b} | (mN/m) ^{c} |
| CMC | 0 | 7.8 ± 1.0 | >73 |
| EC | 100 | <0.01 | <23 |
| V | 15 | 4.6 ± 1.0 | 26 ± 2 |
| VI | 24 | 3.8 ± 0.6 | 30 ± 3 |
| VII | 36 | 2.3 ± 0.4 | 28 ± 2 |
| VIII | 48 | 1.6 ± 0.3 | 26 ± 3 |

^{b} amount of deionized water retained by a specific sample of dry solid particles within 2 minutes;
^{c} surface tension of binary mixtures of methanol and water for which particles drop through the interface into the solution.

One major consideration for using microscopic absorbent particles is the subsequent separation of the hydrated absorbent particles. Solids are separated from a liquid through various types of equipment. However, separation of microscopic particles is typically difficult, especially from petroleum emulsions. The composition of the present invention provides composite absorbent particles which are responsive to water-absorption, greatly facilitating separation. According to the present invention, the composite absorbent particles are of intermediate wettability before absorbing water but become more hydrophilic after absorbing water. Contact angle provides a measure of wettability. Particles with low contact angles are more compatible with polar solvents and remain dispersed in aqueous media. Conversely, particles with high contact angles are more compatible in non-polar solvent and remain dispersed in non-aqueous media. Particles dispersed in an incompatible media have a tendency to aggregate together. Particles which have intermediate wettability may be readily dispersed in both aqueous and non-aqueous media. According to the present invention, the composite absorbent particles before absorbing water are bi-wetting. According to the present invention, the composite absorbent particles before absorbing water are dispersed in a non-polar solvent. According to the present invention, the contact angle of the composite absorbent particles before absorbing water is between 70° and 110°.

Upon absorbing water, the composite absorbent particles of the present invention no longer possess colloidal stability in non-polar solvent. The composite absorbent particles of the present invention disperse in non-polar solvent before absorbing water but, after absorbing water, aggregate into large aggregates of hydrated composite absorbent particles. Separation of aggregates formed by composite absorbent particles after absorbing emulsified water is much easier due to the size of the aggregates. According to Example 1, hydrated composite absorbent particles form very large irregular aggregates which exceed 1 millimeter, as shown in the micrograph inset in FIG. 5. The aggregates settle rapidly under gravity. Aggregates of hydrated composite absorbent particles are separated from non-polar solvent by passing the mixture through a mesh sieve. After absorbing water, the composite absorbent particles become more hydrophilic and less compatible in non-polar solvent. As result, the composite absorbent particles aggregate together forming much larger aggregates which are more easily removed by screening or filtration. According to the present invention, the composite absorbent particles after absorbing water are not bi-wetting. The surface of the composite absorbent particles of the present invention is more hydrophilic after absorbing water. According to the present invention, the composite absorbent particles after absorbing water aggregate in a non-polar solvent. According to the present invention, the contact angle of the composite absorbent particles after absorbing water is between 0° and 70°.

The composite absorbent particles of the present invention are manufactured by first preparing two separate solutions: an aqueous solution and a non-aqueous solution. An emulsion is prepared from the two separate immiscible solutions. The discontinuous phase is subsequently removed through a distillation process leaving any materials previously dissolved and/or dispersed within emulsion droplets as residue. The composite absorbent particles of the present invention comprise an absorbent material coated with an interfacially active material. The interfacially active material acts as emulsion stabilizer for the precursor emulsion and wetting agent for the solid particles, after dehydration of emulsion droplets. The composition of this invention is obtained by dehydrating emulsified droplets, comprising absorptive material, stabilized in a solution comprising interfacially active material by distillation wherein the dispersed phase and the continuous phases are capable of forming a heterogeneous azeotrope. After removal of non-continuous phase, the emulsion droplets form solid particles which remain dispersed in the continuous phase due to their size and wettability. Various non-polar solvents may be used but the interfacially active material must be soluble. Composite absorbent particles are prepared according to Example 1 using toluene as the non-aqueous phase for precursor emulsion. Alternatively, composite absorbent particles are also prepared according to Example 6, using ethyl acetate, butyl acetate, and toluene/ethanol (1:4, v/v) as non-aqueous phase of precursor emulsion. The solvents used in Example 6 are capable of dissolving the interfacially active material and form a heterogeneous azeotrope with water allowing easy dehydration of precursor emulsion droplets. Composite absorbent particles prepared according to Example 1 and Example 6, are similar with intermediate wettability and the ability to absorb water form an emulsion.

Non-limiting examples of solvents which form a heterogeneous azeotropic mixture with water include n-butanol, iso-butanol, chloroform, carbon tetrachloride, methylene chloride, ethyl acetate, butyl acetate, benzene, toluene, and cyclohexane. Non-limiting examples of solvents which form a heterogeneous azeotropic mixture with water and ethanol include chloroform, carbon tetrachloride, benzene, toluene, and n-heptane. Non-limiting examples of solvents which form a heterogeneous azeotropic mixture with water and iso-propanol include benzene and toluene. Non-limiting examples of solvents which form a heterogeneous azeotropic mixture with water and methyl ethyl ketone include carbon tetrachloride and cyclohexane.

Various materials are additionally incorporated into the composition of this invention, according to Example 7. Materials which are dissolved or dispersed into the non-continuous phase of the emulsion remain in the stabilized emulsion droplets. After the dehydration process, both dissolved and dispersed materials are incorporated within the particle. Absorbent particles with specific properties are thus prepared. The specific gravity of the absorbent particle can be increased by incorporating different amounts of high density materials such as inorganic salts and mineral solids.

Non-limiting examples of inorganic salts include sodium chloride, sodium sulphate, sodium bisulphate, calcium chloride, calcium sulphate, calcium carbonate, potassium chloride, potassium sulphate, potassium carbonate, barium sulphate, magnesium chloride, magnesium sulphate, magnesium citrate, and silicon dioxide.

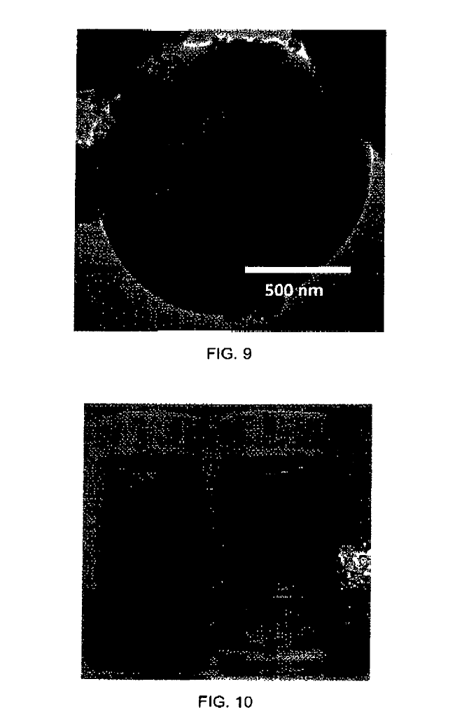

Furthermore, magnetic susceptibility can be imparted to the absorbent material by incorporating an additional magnetic material, according to Example 8. The magnetic material remains dispersed in emulsion droplets during the dehydration process, is incorporated into the composite absorbent particles, and is visible in micrograph of magnetic composite absorbent material taken using TEM, FIG. 9. The residual dehydrated composite absorbent particles comprising magnetic material are magnetically susceptible and are collected using a permanent magnet, FIG. 10.

Non-limiting examples of magnetic materials include iron, magnetite, maghemite, hematite, Fe₃O₄ nanoparticles, and γ-Fe₂O₃ nanoparticles.

Various absorbent materials may be used to prepared composite absorbent particles. According to Example 9, sodium poly(acrylate) is used to prepare composite absorbent particles: the absorbent material is first dissolved in an aqueous phase, the aqueous solution is emulsified into the non-aqueous phase with interfacially active material, and the non-continuous aqueous phase of the resulting precursor emulsions is removed by distillation.

Crosslinking of absorbent material is known to enhance water absorption. Crosslinking absorbent material Thermal crosslinking of absorbent particles is possible by placing the particles in an oven at elevated temperature for a specified amount of time. Chemical crosslinking is possible during the dehydration of emulsion droplets by addition of a crosslinking agent in the aqueous phase of the precursor emulsion and results in additional intermolecular covalent bonds. Crosslinking may also be achieved using multivalent ions and results in electrostatic bridging. Acid treatment and heat treatment can both also be used to crosslink carboxymethyl cellulose.

The present invention is particularly advantageous in removing emulsified water from tight emulsions. Tight emulsions are difficult to break because they contain very small emulsified droplets which are well stabilized. The composition of the present invention is suitable for use in a variety of drying processes. The composition of the present invention removes emulsified water droplets by absorption. The composite absorbent particles are especially suitable for use in an emulsion wherein the continuous phase is non-polar. Due to the unique properties of the composite absorbent particles, the composition can be added to any stream consisting of a mostly non-polar solvent. Composite absorbent particles of intermediate wettability are dispersed into the continuous phase of the emulsion and remain suspended. In one embodiment of the present invention, composite absorbent particles are added to an emulsion. The size of composite absorbent particles is similar to the size of emulsified droplets. The micron-sized composite absorbent particles have very high specific surface area. Due to the surface properties, composite absorbent particles dispersed in an emulsion are very effective in absorbing emulsified water. Accelerated absorption is possible as result of higher potential flux for particles with greater specific surface area. Initial colloidal stability of composite absorbent particles ensures the greater surface area of smaller particles remains accessible to emulsified droplets. Composite absorbent particles which remain dispersed are more likely to contact emulsified water droplets. Once at the interface and in contact with emulsified droplet, absorption of emulsified water occurs. As result of absorbing water, hydrated composite absorbent particles are more hydrophilic and are no longer dispersed in non-polar solvent. Aggregates of hydrated composite absorbent particles are formed in non-polar solvent and are exclusively removed using a size-18 mesh sieve with nominal screen opening size of 1.0 millimeter.

In order to promote absorption of emulsion droplets, it is important to provide sufficient agitation to the emulsion, after adding composite absorbent particles, for attachment of composite absorbent particles onto emulsified water droplets. In one embodiment of the present invention, emulsion and composite absorbent particles are well mixed inside a tank with a mechanical stirrer. In another embodiment of the present invention, the emulsion and composite absorbent particles are well mixed inside a pipeline under turbulent flow. In order to promote absorption of emulsion droplets, it is important to provide sufficient time for the composite absorbent particles to absorb emulsified water. In one embodiment of the present invention, emulsion and composite absorbent particles are stored inside a tank for a prescribed amount of time. In another embodiment of the present invention, the emulsion and composite absorbent particles are transported inside a pipeline for specified amount of time.

Upon hydration of composite absorbent particles, the granular aggregates formed are macroscopic (larger than 1 millimeter) and readily separated using common separation equipment. Aggregates of hydrated composite absorbent particles are removed using clarifier, settler, decanter, cyclone, screen, percussive screen/shaker, and inclined plate settler. The use of the composite absorbent particles of the present invention within many existing processes is possible. Specific sections of a plant process can be treated without significantly affecting other process steps due to the relative ease of separating aggregates of hydrated composite absorbent particles. According to the present invention, the composition for drying an emulsion may be added continuously to prevent accumulation of emulsified water. Also according to the present invention the composition for drying an emulsion may be used to supplement other equipment in response to abnormal operation conditions. Such operating conditions may be the result of unplanned equipment downtime or when the feed contain more emulsified water than anticipated.

Magnetic materials include various materials that are either ferromagnetic, ferrimagnetic, paramagnetic, or superparamagnetic. Ferromagnetism occurs in iron, nickel, cobalt, rare earth metals, and their alloys. Ferrimagnetic materials are also permanent magnets with unpaired electrons in their molecular structure but the magnetic moments prefer to align in opposite directions. Many ferrites including magnetite, maghemite, hematite, manganese ferrite, nickel-zinc ferrite, strontium ferrite, barium ferrite, and cobalt ferrite are examples of ferrimagnetic materials. Superparamagnetism occurs in ferromagnetic and ferromagnetic materials with sufficiently small physical dimension restricting such materials to a single-magnetic domain which align themselves along an applied magnetic field. However, in the absence an applied magnetic field, the magnetization of a superparamagnetic material is lost due to the influence of Brownian motion. Iron oxide nanoparticles including Fe₃O₄ and γ-Fe₂O₃ can exhibit superparamagnetism. The critical size of both Fe₃O₄ and γ-Fe₂O₃ for superparamagnetic behaviour is between 20 and 30 nanometers. Magnetic separation of composition of the present invention is possible when composite absorbent particles further comprise magnetic material which imparts magnetic susceptibility to the composite absorbent particles. In addition to the unique properties of composite magnetic particles of the present invention, ideally suited for drying emulsions, magnetic composite absorbent particles are further separated magnetically before or after absorption of emulsified water.

During various stages of processing, petroleum is often stored in large tanks. When an emulsion is stored, phase separation is inevitable and accumulation of sludge in process equipment is detrimental. Sludge, consisting of separated water, emulsified water, and solids, accumulates at the bottom of storage tanks, pipelines, separation vessels, and other equipment. Separation and removal of this sludge is difficult and often requires shutting down in order to service the equipment. The composition of the present invention is suitable for removing water from petroleum emulsions in various process equipment including storage tanks, pipelines, separation vessels, and other equipment. The use of the composition of the present invention to dry an emulsion is possible without interrupting an entire process.

Due to the unique properties of the composite absorbent particles, the composition of the present invention can be added to any stream consisting of a mostly non-polar solvent where they remain dispersed until they absorb sufficient water for hydrated composite absorbent particles to lose colloidal stability and form large aggregates. Aggregates formed by hydrated composite absorbent particles which comprise magnetic material are also magnetically responsive. Separation of dispersed magnetic composite absorbent particles is possible using a magnet. Separation of hydrated magnetic composite absorbent particle aggregates is also possible using a magnet.

The composition and processes of the present invention are suitable for drying emulsions present in storage tanks, pipelines, and separation vessels. According to the present invention, the composition for drying an emulsion is added to a petroleum emulsion in a large storage tank. The composition may be added directly to the storage tank or into an upstream process such that hydrated magnetic composite absorbent particles accumulate inside the storage tank. The accumulated aggregates of hydrated magnetic composite absorbent particles are separated using a magnet attached to a mechanical mechanism lowered into the storage tank. Also according to the present invention, the composition for drying an emulsion is added into a process stream line and later removed using a stationary magnet. The use of the composite absorbent particles in reducing water content of petroleum emulsions may lead to lowered lost-production time from reduced load on operational maintenance.

Bitumen Extraction

Bitumen is extracted from shallow bituminous sand deposits using large shovels and dump trucks in an open-pit mine. Overburden is removed and bitumen-rich ore is collected and transported to an extraction plant. Inside the extraction plant, the bitumen is liberated from sand grains using heat and chemical additives. Liberated bitumen is separated from gangue by froth flotation. During flotation, bitumen attaches onto hydrophobic air bubbles and rise to the surface where a large mechanical skim removes the froth. Bitumen froth contains bitumen, air, water, and fine solids. Before bitumen can be further processed, contaminants must be separated. Bitumen produced from surface mining is upgraded into synthetic crude oil at a separate facility known as a bitumen upgrader.

The composition and processes of the present invention are suitable for removing water from emulsions encountered during bitumen extraction such as diluted bitumen, bitumen froth, and diluted bitumen froth. Current methods for treating bitumen froth include naphthenic froth treatment and paraffinic froth treatment. Naphthenic froth treatment reduces water content to approximately 2.5 wt %. Naphthenic froth treatment begins with dilution of bitumen froth with naphtha followed by scroll centrifuges, inclined plate settler, filtration, and disc centrifuges. Disc centrifuges are being replaced with inclined plate settlers and cyclones. Paraffinic froth treatment reduces water content to less than 0.5 wt %. The use of paraffinic solvent, including pentane and hexane, causes precipitation of asphaltenes which form large flocs along with water droplets. Due to the removal of the asphaltenes, bitumen diluted with paraffinic solvent is partially upgraded. The amount of asphaltene precipitation depends on the diluent to bitumen ratio. Generally, the paraffinic process requires approximately three time the amount of solvent compared to the naphthenic process and yields less bitumen due to removal of approximately half of asphaltenes. Paraffinic froth treatment begins with dilution of bitumen froth with paraffin followed by gravity settlers.

According to the present invention, the composition for drying an emulsion is added to the diluted bitumen froth and hydrated composite absorbent particles are later removed. The use of absorbents in reducing water content of diluted bitumen froth in a naphtha-based process may lead to reducing reliance on centrifuges, inclined plate settlers, and cyclones. The use of the composite absorbent particles in reducing water content of diluted bitumen froth in a paraffin-based process may lead to reducing the amount of paraffinic solvent used or lead to changes in ashphaltene rejection.

In-Situ Production

Many bitumen deposits are found in bituminous sand formations which are too deep for surface mining to be economical. Recovery of such deposits is possible using thermal recovery methods which increase the temperature of the formation in order to reduce the viscosity of bitumen. Cyclic steam stimulation (CSS) with one or multiple wells alternates between an injection mode, when steam is pumped into the reservoir, and a production mode, when bitumen is returned. Steam-assisted gravity drainage (SAGD) is a recovery technology which requires two parallel wells: heated steam from an injector well generates a steam chamber which heats bitumen allowing it sufficient mobility to drain into a producer well located directly beneath the steam chamber. Bitumen produced using various recovery technologies typically contains emulsified water in the bitumen. The performance of both CSS and SAGD processes have been optimized with addition of solvent and using alternative methods of providing heat, from in-situ combustion of bitumen to generated steam to microwave heating.

Bitumen, produced using in-situ recovery methods, is typically blended with naphtha (DILBIT) or with synthetic crude oil (SYNBIT). For most in-situ production technologies, the produced mixture at the surface is a mixture of bitumen, water, steam, and solids. From the wellhead, produced mixture is degassed. The liquid stream is cooled, mixed with diluent, and sent to a water knock out drum where free water is removed. The outlet stream contains bitumen with 10% emulsified water and is sent to a treater where it is further reduced to below 0.5% water and sediment. Treater units use a combination of heat, gravity segregation, chemical additives, and electric current to break emulsions.

The composition and processes of the present invention are suitable for removing emulsified water from emulsions encountered during in-situ bitumen production. According to the present invention, the composition for drying an emulsion is added to a production fluid where composite absorbent particles absorb emulsified water. In one embodiment of the present invention, the composition for drying an emulsion is added to the production fluid after separating free water. In another embodiment of the present invention, the composition for drying an emulsion is added to the production fluid after treating the bitumen emulsion. The aggregates of hydrated composite absorbent particles are separated at various points of the process depending on when the composition of the present invention is added to the emulsion and the amount of time required for the composition of the present invention to absorb water. According to the present invention, composite absorbent particles can be added to the emulsion during transport by pipeline or in vessels. The time required for the treated emulsion to reach its destination may be used to reduce water content of the emulsion. The use of the composite absorbent particles in reducing water content of bitumen emulsions and diluted bitumen emulsions may lead to reduced demand for treater units and greater possible production rate without affecting water and sediment.

Drilling Fluid

The composition of the present invention is suitable for removing water from invert drilling fluid. Drilling fluids are available in as freshwater-based systems, saltwater-based systems, pneumatic systems, and oil-based systems. Oil-based and synthetic-base drilling fluid is often referred to as invert drilling fluid. During operation, invert drilling fluid may become contaminated by formation water. The high-shear environment of the borehole, especially near the drillstring, provides sufficient energy to emulsify water. Lime is also commonly used as additive in drilling fluid. Excessive water in invert drilling fluid can cause problems including phase inversion. Management of invert drilling fluid typically consists of adding more surfactant to stabilize the emulsified water or diluting with more base oil to lower water content. Drilling operations typically employ shakers and centrifuges to remove drill cuttings from drilling fluid.

The composition and processes of the present invention is suitable for removing emulsified water from invert drilling fluid. According to the present invention, removal of water is accomplished by first adding the composition of the present invention into the drilling fluid circulation system where it will contact emulsified water droplets and absorb water present in the non-aqueous solvent, due to its unique properties; once composite absorbent particles absorb water, their surface becomes more hydrophilic and composite absorbent particles begin to lose colloidal stability in the non-polar drilling fluid, forming large aggregates of hydrated composite absorbent particles. Also according to the present invention, the aggregates of hydrated composite absorbent particles are removed from the drilling fluid over shakers used to remove drill cuttings or using a centrifuge.

Water content of mineral oil emulsion stabilized by surfactant is reduced according to Example 10. Micrograph of treated mineral oil emulsion samples show reduced amount emulsified water (FIG. 11). Using composite absorbent particles prepared according to Example 1 and magnetic composite absorbent particles prepared according to Example 8, emulsified water is absorbed and removed. After absorbing water, aggregates of hydrated composite absorbent particles, prepared according to Example 1, settle rapidly under gravity; while magnetic composite absorbent particles, prepared according to Example 8, are separated under a magnetic field. Magnetic separation is more effective than gravity settling for high-viscosity emulsions.

Water content of diluted-bitumen emulsion is reduced according to Example 12, Example 13, and Example 14. The water content of various treated diluted-bitumen emulsions is tracked in Table 4, Table 5, and Table 6. Table 4 is a plot of water content for diluted-bitumen emulsions treated with composite absorbent particles and magnetic composite absorbent particles according to Example 12. Table 5 is a plot of water content for diluted-bitumen emulsions treated with composite absorbent particles and magnetic composite absorbent particles according to Example 13. Table 6 is a plot of water content for diluted-bitumen emulsions treated with composite absorbent particles and magnetic composite absorbent particles according to Example 14. Table 7 is a plot of water content for diluted bitumen froth treated with composite absorbent particles and magnetic composite absorbent particles according to Example 15.

Using composite absorbent particles, prepared according to Example 1 and Example 4; magnetic composite absorbent particles, prepared according to Example 8; and CMC particles coated with EC, prepared according to Example 11; emulsified water is absorbed and removed from diluted-bitumen emulsion samples. After absorbing water, aggregates of hydrated composite absorbent particles, prepared according to Example 1 and Example 4, settle rapidly under gravity; while magnetic composite absorbent particles, prepared according to Example 8, are separated under a magnetic field. As evident in Table 4, composite absorbent particles, prepared according to Example 1 and Example 8, outperformed both unmodified CMC particles and CMC particles coated with EC by solvent evaporation, prepared according to Example 11, in reducing water content of diluted-bitumen emulsion. With sufficient agitation, water absorption is more rapid for composite absorbent particles, prepared according to Example 1, than CMC particles coated with EC, prepared according to Example 11.

Water content of diluted-bitumen froth is reduced according to Example 15. Using composite absorbent particles prepared according to Example 1 and magnetic composite absorbent particles prepared according to Example 8, emulsified water is absorbed and removed. After absorbing water, aggregates of hydrated composite absorbent particles, prepared according to Example 1, settle rapidly under gravity; while magnetic composite absorbent particles, prepared according to Example 8, are separated under a magnetic field. The water content of treated diluted-bitumen froth is tracked in Table 7. Aggregates of hydrated composite absorbent particles separated from bitumen froth contain trapped bitumen and emulsified water, Table 3.

TABLE 3

| | Emulsified Water Absorbed | Trapped Bitumen in Absorbent |
|---|---|---|
| Sample | (g/g) | (wt %) ^{‡} |
| A | 3.4 ± 1.0 | 6.5 ± 1.1 |
| B | 3.1 ± 0.8 | 5.4 ± 1.6 |
| C | 2.2 ± 0.3 | 3.8 ± 1.0 |

^{‡} Based on dry mass of recovered absorbent particle aggregates.

It is an objective of the present invention to provide a composition for removing emulsified water from an emulsion with non-aqueous continuous phase; the composition comprising composite absorbent particles with properties especially suited for this task. The structure of the composite absorbent particles of the present invention is such that the composite absorbent particles possess a surface of interfacially active material, improving their performance compared to contemporary water-absorbents. The composite absorbent particles of the present invention are prepared by dehydrating a precursor emulsions and the resulting particles are of similar size to oilfield emulsions which enhances their dewatering performance. The composite absorbent particles of the present invention are responsive to water-absorption, the changes to properties of the composite absorbent particles upon absorbing water facilitates their removal from the emulsion.

### Example 1

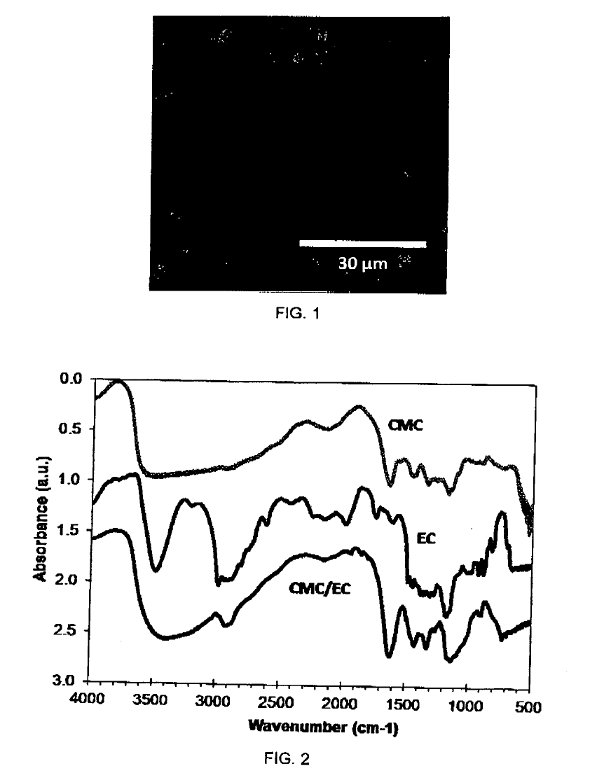

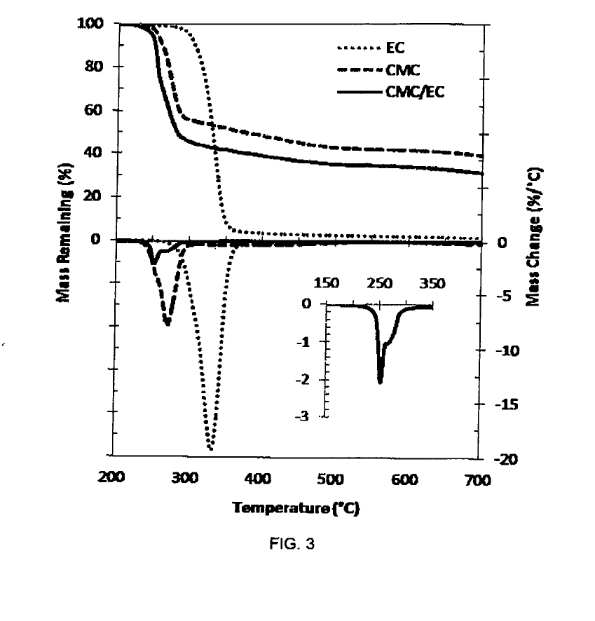

An aqueous phase is prepared by dissolving sodium carboxymethyl cellulose (Acros Organics; average M.W. 250,000 g/mol; DS=0.7) into deionized water at ambient temperature. A separate non-aqueous phase is prepared by dissolving ethylcellulose ethyl cellulose (Sigma-Aldrich; 48% ethoxyl content) into toluene (Fisher Chemical; HPLC grade) at ambient temperature. The aqueous phase, containing 2.0 wt % dissolved CMC, is emulsified into the non-aqueous phase, containing 2.0 wt % dissolved EC, (1:1 w/w) using a Fisher Scientific PowerGen handheld homogenizer for 60 seconds. The continuous phase of the resulting water-in-toluene emulsion was confirmed by placing a small droplet of the emulsion onto a Petri dish with water. The precursor emulsion is transferred to a round-bottom flask equipped with magnetic stirrer and Dean-Stark apparatus. The precursor emulsion is preheated to 50° C., emulsified again using homogenizer for 60 seconds, and heated to reflux until water is removed from the emulsion by distillation. After cooling the dehydrated emulsion to ambient temperature, solids are recovered from the dispersion of composite absorbent particles using a centrifuge at 3000 rpm. Separated composite absorbent particles are washed several times with toluene and ethanol (Commercial Alcohols; 99%). Excess solvent was removed using a rotary evaporator under reduced pressure. Composite absorbent particles are placed in an oven at 120° C. for 12 h. After drying the residue, a free flowing white solid is recovered. The product was crushed and immobilized onto conductive tape, placed onto a sample holder, and analyzed using a Hitachi S-2700 Scanning Electron Microscope (SEM). SEM image, presented in FIG. 1, shows spherical shape of individual composite absorbent particles prepared by emulsion dehydration, according to Example 1, less than 10 micrometers in diameter. The spherical shape of composite absorbent particles is in part due to the process of emulsion dehydration used to prepare particles. Fourier-transform infrared (FTIR) absorption spectra of composite absorbent particles prepared according to Example 1, taken using BioRad 2000 instrument with a diffuse internal reflectance accessory, is shown in FIG. 2. FTIR spectra of composite absorbent particles (i.e. CMC/EC in FIG. 2), taken in KBr, encompass all characteristic peaks of CMC and EC, including a broad peak at 3328 cm⁻¹ due to stretching vibration of hydrogen-bonded —OH groups, multiple peaks between 2892 and 2863 cm⁻¹ assigned to C—H stretching, a strong peak at 1608 cm⁻¹ as a result of —COO⁻ vibration, a peak at 1412 cm⁻¹ due to shearing of —CH₂-groups, a strong peak at 1107 cm⁻¹ from stretching of ether groups, and a peak at 886 cm⁻¹ due to CH₃ vibrations. The composition of composite absorbent particles was determined by thermogravimetric analysis performed using a TA Instruments Q200 thermo-gravimetric analyzer with a constant heating rate of 5° C./min. The results of thermogravimetric analysis, presented in FIG. 3, show the onset temperature of EC decomposition at 317° C. and complete decomposition at 450° C. The onset temperature for CMC decomposition was 264° C. and 45 wt % of CMC remained after heating to 450° C. The decomposition of composite absorbent particles (i.e. CMC/EC in FIG. 3), prepared according to Example 1, started at 246° C. with only a single decomposition event below 300° C. The decrease in the onset temperature for thermal decomposition of the composite absorbent particles, along with a lack of a secondary decomposition event, suggests the formation of composite absorbent particles between CMC and EC. The thermal decomposition characteristic of composite absorbent particles, prepared according to Example 1, was distinctively different from that of a simple physical admixture of CMC and EC. The sample of composite absorbent particles, prepared according to Example 1, contains 20 wt % EC.

### Example 2

A sample of composite absorbent particles, prepared according to Example 1, as well as EC particles and CMC particles are gently placed on the surface of a biphasic mixture of deionized water and toluene. In FIG. 4, EC particles penetrate into the upper non-polar phase, where EC begins to dissolve. However, EC particles do not cross the interface and remain in the upper non-aqueous layer. In FIG. 4, CMC particles penetrate into the upper non-polar phase, settled to the toluene-water interface, and crossed into the lower aqueous phase, where CMC begins to dissolve. In contrast to CMC and EC, the composite absorbent particles, prepared according to Example 1, attached onto the interface formed by the upper non-aqueous phase and the lower aqueous phase. Attachment of composite absorbent particles, prepared according to Example 1, on the toluene-water interface, visible in FIG. 4, provides clear indication of interfacial activity. Composite absorbent particles, prepared according to Example 1, disperse in non-polar solvents, such as toluene, before absorbing water but aggregate together in non-polar solvents after absorbing water, shown in FIG. 5.

### Example 3

The critical surface tension at which fine particles no longer remain attached to the air-liquid interface is indicative of particle wettability. For a high surface tension liquid, hydrophobic particles will remain at the interface while hydrophilic particles will quickly penetrate into the liquid. Uncoated CMC powders were completely wet by pure water (i.e. 73 mN/m) while EC powders were completely wet only by pure methanol (i.e. 23 mN/m). The wettability of micron size CMC-EC composite particles was evaluated using critical surface tension measured in binary mixtures of methanol and water with the surface tension of the liquids tuned by adjusting mixture composition. The critical surface tension of composite absorbent particles, prepared according to Example 1, is 26.4 mN/m. The wettability of composite absorbent particle, prepared according to Example 1, indicates that EC remains on the surface where it has significant impact on particle wettability.

### Example 4

An aqueous solution is prepared by dissolving CMC into deionized water; while a separate non-aqueous solution is prepared by dissolving EC into toluene. Precursor emulsions are prepared with CMC-solution and EC-solution using different parameters such as the ratio between aqueous phase and non-aqueous phase, the concentration of CMC, and the concentration of EC. The aqueous phase is emulsified into the non-aqueous phase using high-speed homogenizer for 60 seconds. The resulting water-in-toluene emulsion is transferred to a round-bottom flask equipped with a homogenizer and Dean-Stark apparatus. Emulsions are prepared using 3 wt % CMC, 2 wt % CMC, 1 wt % CMC, and 0.5 wt % CMC. Emulsions are prepared using 3 wt % EC, 2 wt % EC, 1 wt % EC, and 0.5 wt % EC. Emulsions are prepared using a phase ratio (i.e. mass of aqueous phase to mass of non-aqueous phase) of 1:1, 2:3, and 1:10. The emulsions samples are subsequently heated to reflux until water is removed from emulsions. After cooling to ambient temperature, the dispersion containing solid particles were transferred to a centrifuge and separated at 3000 rpm. Separated composite absorbent particles are washed several times with toluene and ethanol. Excess solvent was removed using a rotary evaporator under reduced atmosphere. Composite absorbent particles are placed in an oven at 120° C. for 12 h. The Sauter mean diameter (d_{3,2}) of composite absorbent particles, prepared according to Example 4, measured by light scattering using Malvern Mastersizer 2000 instrument with a small volume dispersion accessory or using Malvern Mastersizer 3000 instrument with an extended volume dispersion accessory, range between 25 nanometers and 100 micrometers, as shown in FIG. 6. Water-absorbency of the composite absorbent particles, prepared according to Example 4, is determined gravimetrically by saturating composite absorbent particles with deionized water and subsequently removing excess water by gravity filtration.

### Example 5

An aqueous solution is prepared by dissolving CMC into deionized water; while a separate non-aqueous solution is prepared by dissolving EC into toluene. The aqueous phase, containing 1.0 wt % dissolved CMC, is emulsified into the non-aqueous phase, containing 2.0 wt % dissolved EC, (1:4 w/w) using a homogenizer for 60 seconds. The resulting water-in-toluene emulsion is transferred to a round-bottom flask equipped with a Fisher Scientific Model 500 ultrasonic dismembrator and Dean-Stark apparatus. The emulsified mixture is subsequently heated to reflux until water was removed from the emulsion; ultrasonic agitation was applied continuously during the dehydration process. After cooling the dehydrated emulsion to ambient temperature, solids are recovered from the dispersion of composite absorbent particles using a centrifuge at 3000 rpm. Separated composite absorbent particles are washed several times with toluene and ethanol. Excess solvent was removed using a rotary evaporator under reduced pressure. Composite absorbent particles are placed in an oven at 120° C. for 12 h. After drying the residue, a free flowing white solid is recovered. SEM micrograph in FIG. 7 and particle size distribution in FIG. 8, measured using Malvern Zetasizer Nano, show that composite absorbent particles, prepared according to Example 5, are more uniform in size than composite absorbent particles prepared according to Example 1.

### Example 6

An aqueous solution is prepared by dissolving 2 wt % CMC into deionized water. Separately, non-aqueous solutions are prepared by dissolving 2 wt % EC in ethyl acetate ethyl acetate (Fisher Chemical; ACS grade), butyl acetate (Fisher Chemical; ACS grade), and a mixture of toluene and ethanol (4:1 v/v). The aqueous phase, containing 2.0 wt % dissolved CMC, is emulsified into the non-aqueous phase, containing 2.0 wt % dissolved EC, (1:1 w/w) using a Fisher Scientific PowerGen handheld homogenizer for 60 seconds. The continuous phase of the resulting emulsion with non-aqueous continuous phase was confirmed by placing a small droplet of the emulsion onto a Petri dish with water. The precursor emulsion is transferred to a round-bottom flask equipped with magnetic stirrer and Dean-Stark apparatus. The precursor emulsion is preheated to 50° C., emulsified again using homogenizer for 60 seconds, and heated to reflux until water is removed from the emulsion by distillation. After cooling the dehydrated emulsion to ambient temperature, solids are recovered from the dispersion of composite absorbent particles using a centrifuge at 3000 rpm. Separated composite absorbent particles are washed several times with toluene and ethanol (Commercial Alcohols; 99%). Excess solvent was removed using a rotary evaporator under reduced pressure. Composite absorbent particles are placed in an oven at 120° C. for 12 h. After drying the residue, a free flowing white solid is recovered.

### Example 7

An aqueous solution is prepared by dissolving CMC and potassium chloride (KCl) into deionized water; while a separate non-aqueous solution is prepared by dissolving EC into toluene. The aqueous phase, containing 1.0 wt % dissolved CMC and 0.5 wt % dissolved KCl, is emulsified into the non-aqueous phase, containing 2.0 wt % dissolved EC, (1:1 w/w) using a homogenizer for 60 seconds. The resulting water-in-toluene emulsion is transferred to a round-bottom flask equipped with a Fisher Scientific Model 500 ultrasonic dismembrator and Dean-Stark apparatus. The emulsified mixture is subsequently heated to reflux until water was removed from the emulsion; ultrasonic agitation was applied continuously during the dehydration process. After cooling the dehydrated emulsion to ambient temperature, solids are recovered from the dispersion of composite absorbent particles using a centrifuge at 3000 rpm. Separated composite absorbent particles are washed several times with toluene and ethanol. Composite absorbent particles are placed in an oven at 120° C. for 12 h. After drying the residue, a free flowing white solid is recovered.

### Example 8

An aqueous phase is prepared by dissolving CMC into deionized water and dispersing and dispersing iron oxide nanoparticles (<50 nm diameter, Sigma-Aldrich; CAS 1309-37-1) into the CMC solution; while a separate non-aqueous solution is prepared by dissolving EC into toluene. The aqueous phase, containing 1.0 wt % dissolved CMC, is emulsified into the non-aqueous phase, containing 2.0 wt % dissolved EC, (1:4 w/w) using a homogenizer for 60 seconds. The resulting water-in-toluene emulsion is transferred to a round-bottom flask equipped with a Fisher Scientific Model 500 ultrasonic dismembrator and Dean-Stark apparatus. The emulsified mixture is subsequently heated to reflux until water was removed from the emulsion; ultrasonic agitation was applied continuously during the dehydration process. After cooling the dehydrated emulsion to ambient temperature, solids are recovered from the dispersion of composite absorbent particles using strong permanent magnet. Separated composite absorbent particles are washed several times with toluene and ethanol. Magnetic composite absorbent particles are placed in an oven at 120° C. for 12 h. After drying the residue, a free flowing brown solid is recovered. Magnetic composite absorbent particles, prepared according to Example 8, were placed in a JEOL 2010 Transmission Electron Microscope (TEM). TEM micrograph, presented in FIG. 9, show iron oxide nanoparticles within individual magnetic composite absorbent particles. The wettability and magnetic susceptibility is confirmed by first dispersing magnetic composite absorbent particles, prepared according to Example 8, into toluene and subsequently recovering them using a permanent magnet, shown in FIG. 10.

### Example 9

An aqueous phase was prepared by slowly dissolving poly(acrylic acid) partial sodium salt (Aldrich; CAS 76774-25-9) into deionized water; while a non-aqueous phase was prepared by dissolving EC into toluene. A separate organic phase was prepared by dissolving EC into toluene. The aqueous phase was emulsified into the organic phase using homogenizer. The resulting water-in-toluene emulsion was transferred to a round-bottom flask equipped with magnetic stirrer and Dean-Stark apparatus. The emulsified mixture was subsequently heated to reflux until water was removed from the emulsion. After cooling to ambient temperature, solids were transferred to a centrifuge and separated at 3000 rpm. Particles were washed several times with toluene and ethanol. Recovered particles were placed in an oven at 120° C. for 72 h. After drying, a white solid was recovered.

### Example 10

Water-in-mineral oil emulsions, stabilized by 0.75 wt % SPAN® 80 (Sigma; CAS 1338-43-8), are prepared by dissolving non-ionic surfactant in mineral oil (Sigma; CAS 8042-47-5) and emulsifying deionized water into mineral oil using a homogenizer for 2 minutes. The resulting emulsion contained 5.9 wt % emulsified water, determined by Karl-Fischer titration using a G.R. Scientific Cou-Lo 2000 automatic coulometric titrator. Samples of the mineral oil emulsion are transferred to test tubes and subsequently treated with 2.5 wt % composite absorbent particles, prepared according to Example 1, or 2.5 wt % magnetic composite absorbent particles, prepared according to Example 8. The treated mineral oil emulsions samples are placed in a vortex mixer for 30 seconds, shaken in a mechanical shaker for 12 h at 200 cycles/min. Mineral oil emulsion sample treated with composite absorbent particles, prepared according to Example 1, is subsequently left to settling under gravity for 1 h while sample treated with magnetic composite absorbent particles, prepared according to Example 8, is subsequently placed over a permanent magnet for 1 h to collet magnetic particles. The water content of treated mineral oil emulsion samples is measured by Karl-Fischer titration of emulsion aliquots taken at the midway point of the sample. Adding 2.5 wt % composite absorbent particles, water content at midway point of treated emulsion was reduced to less than 30% of the original emulsified sample following 12 h of mechanical agitation and 1 h of gravity settling. Following 12 h of mechanical agitation and separation of magnetic composite absorbent particles using a hand magnet, emulsions treated with 2.5 wt % magnetic composite absorbent particles exhibited reduced water content at the midway point corresponding to less than 12% of the originally emulsified water. Untreated emulsion samples exhibit poor phase separation with over 70% of emulsified water remaining after 12 h of mechanical agitation followed by 1 h of gravity settling. Micrographs of mineral oil emulsions samples prepared according to Example 10, presented in FIG. 11, show reduced amount of emulsified water droplets for emulsion treated. After absorbing water, aggregates of hydrated composite absorbent particles prepared according to Example 1 are removed by passing emulsion over a mesh screen with 1 millimeter opening.

### Example 11

Unmodified CMC particles (Acros Organics; average M.W. 250,000 g/mol; DS=0.7) are sorted using a size-20 and size-35 sieves, with a nominal mesh size of 0.85 millimeters and 0.50 millimeters, respectively; particles smaller than 0.50 millimeters or larger than 0.85 millimeters are rejected. CMC particles are coated with EC (Sigma-Aldrich; 48% ethoxyl content) through solvent evaporation by immersing unmodified CMC particles, between 0.50 and 0.85 millimeters, in a 2 wt % solution of EC in toluene (Fisher Chemical; HPLC grade), decanting excess solution, drying in a rotary evaporator under reduced pressure, washing with toluene and ethanol, and placing in an oven at 120° C. for 12 h. Both unmodified CMC particles and CMC particles coated with EC by solvent evaporation are off-white granular solids. CMC particles coated with EC by solvent evaporation contain 3 wt % EC, determined by thermogravimetric analysis. CMC particles are coated with bitumen through solvent evaporation by immersing unmodified particles greater than 1 millimeter in a 2 wt % solution of bitumen in toluene, decanting excess solution, drying in a rotary evaporator under reduced pressure, washing with toluene and ethanol, and placing in an oven at 120° C. for 12 h. CMC particles coated with bitumen by solvent evaporation are brown granular solids. CMC particles coated with bitumen by solvent evaporation contain 3 wt % bitumen, determined by thermogravimetric analysis.

### Example 12

Emulsions are prepared by emulsifying plant process water into bitumen diluted with heavy naphtha. Heavy naphtha-diluted bitumen was prepared with a naphtha/bitumen ratio of 0.65. After dilution, the mixture is shaken in a mechanical shaker overnight at 200 cycles/min. Process water-in-diluted bitumen emulsions are emulsified using a high speed homogenizer at 30 000 rpm for 3 minutes. The resulting process water-in-diluted bitumen emulsion is stable with average drop size less than 5 micrometers. The water content of the diluted bitumen emulsion is 4.7 wt %. Samples of diluted-bitumen emulsion are transferred into individual test tubes and treated with 2.5 wt % unmodified CMC particles, prepared according to Example 11; 2.5 wt % CMC particles coated with EC by solvent evaporation, also prepared according to Example 11; 2.5 wt % composite absorbent particles, prepared according to Example 1; or 2.5 wt % composite absorbent particles, prepared according to Example 4. Treated emulsion samples are agitated in a vortex mixer for various amounts of time and left to phase separate at ambient condition under the force of gravity for 1 h. The water content of treated diluted-bitumen emulsion samples is measured by Karl-Fischer titration of emulsion aliquots taken at the midway point of the sample. Emulsion samples treated with composite absorbent particles prepared according to Example 4 (CMC/EC-B and CMC/EC-C in Table 4) was less than half its original value after only 30 s in the vortex mixer. In comparison, water content at halfway point of emulsions samples treated with larger absorbent particles prepared according to Example 11 (CMC and CMC/EC-A in Table 4) was reduced by less than 30% after 90 s in the vortex mixer. The plot of water content for diluted-bitumen emulsion samples treated with the composite absorbent particles of the present invention are shown in Table 4. As evident in Table 4, both samples treated with composite absorbent particles prepared according to Example 4 outperformed both unmodified CMC particles and CMC particles coated with EC by solvent evaporation, both prepared according to Example 11.

TABLE 4
Water Content of Diluted Bitumen Emulsion Samples.

| Time in | | | | | |
|---|---|---|---|---|---|
| Vortex | | | | | |
| Mixer | | | | | |
| (s) | BLK | CMC | CMC + EC | CMC/EC #1 | CMC/EC #8 |
| 0 | 4.46% | 4.46% | 4.46% | 4.46% | 4.46% |
| 30 | 4.44% | 4.17% | 4.06% | 0.75% | 1.60% |
| 60 | 4.34% | 3.84% | 3.57% | 0.48% | 0.72% |
| 90 | 4.31% | 3.67% | 3.34% | 0.44% | 0.51% |

### Example 13

A diluted-bitumen emulsion with water content of 5.0 wt % is prepared by emulsifying process water taken from an industrial facility into bitumen diluted with heavy naphtha using a naphtha/bitumen ratio of 0.65. Samples of diluted-bitumen emulsion are transferred into individual test tubes and treated with various amounts, either 0.5 wt %, 1.5 wt %, or 3.0 wt %, of composite absorbent particles prepared according to Example 1 (CMC/EC #1 in Table 5), magnetic composite absorbent particles prepared according to Example 8 (CMC/EC #8 in Table 5), or CMC particles coated with EC by solvent evaporation, prepared according to Example 11 (CMC+EC in Table 5). Diluted-bitumen samples treated with composite absorbent particles prepared according to Example 1 and diluted-bitumen samples treated with CMC particles coated with EC by solvent evaporation prepared according to Example 11 are placed in a mechanical shaker for 2 hours and subsequently left to settle by gravity in a vertical position for 1 hour. Diluted-bitumen samples treated with magnetic composite absorbent particles prepared according to Example 8 are placed in a mechanical shaker for 2 hours and subsequently placed above a permanent magnet to separate magnetic composite absorbent particles. The water content of treated diluted-bitumen emulsion samples is measured by Karl-Fischer titration of emulsion aliquots taken at the midway point of the sample. The water content of treated diluted-bitumen emulsion samples is measured after 2 hours in a mechanical shaker followed by 1 hour of gravity settling in vertical position or magnetic separation: as plotted in Table 5, water content of diluted-bitumen emulsion sample treated with composite absorbent particles, prepared according to Example 11, is reduced by 96% using 3.0 wt %; by 49% using 1.5 wt %; and by 16% using 0.5 wt %. Also plotted in Table 5, water content of diluted-bitumen emulsion sample treated with composite absorbent particles, prepared according to Example 1, is reduced by 97% using 3.0 wt %; by 87% using 1.5 wt %; and by 31% using 0.5 wt %. Also plotted in Table 5, water content of diluted-bitumen emulsion sample treated with magnetic composite absorbent particles, prepared according to Example 8, is reduced by 94% using 3.0 wt %; by 72% using 1.5 wt %; and by 25% using 0.5 wt %.

TABLE 5
Amount of Emulsified Water Remaining in Emulsion Samples.

| | CMC + EC | CMC/EC #1 | CMC/EC #8 |
|---|---|---|---|
| 0.5 wt % | 95% | 76% | 77% |
| 1.0 wt % | 94% | 33% | 36% |
| 3.0 wt % | 90% | 3% | 7% |

### Example 14

A diluted-bitumen emulsion with water content of 5.0 wt % is prepared by emulsifying process water taken from an industrial facility into bitumen diluted with heavy naphtha using a naphtha/bitumen ratio of 0.65. Samples of diluted-bitumen emulsion are transferred into individual test tubes and treated with various amounts, either 0.5 wt %, 1.5 wt %, or 3.0 wt %, of composite absorbent particles prepared according to Example 1 (CMC/EC #1 in Table 6), magnetic composite absorbent particles prepared according to Example 8 (CMC/EC #8 in Table 6), or CMC particles coated with EC by solvent evaporation, prepared according to Example 11 (CMC+EC in Table 6). Diluted-bitumen samples treated with composite absorbent particles prepared according to Example 1 and diluted-bitumen samples treated with CMC particles coated with EC by solvent evaporation prepared according to Example 11 are placed in a vortex mixer for 30 seconds and subsequently left to settle by gravity in a vertical position for 1 hour. Diluted-bitumen samples treated with magnetic composite absorbent particles prepared according to Example 8 are placed in a vortex mixer for 30 seconds and subsequently placed above a permanent magnet to separate magnetic composite absorbent particles. The water content of treated diluted-bitumen emulsion samples is measured by Karl-Fischer titration of emulsion aliquots taken at the midway point of the sample. The water content of treated diluted-bitumen emulsion samples is measured after 30 seconds in a vortex mixer followed by 1 hour of gravity settling in vertical position or magnetic separation: as plotted in Table 6, water content of diluted-bitumen emulsion sample treated with composite absorbent particles, prepared according to Example 11, is reduced by 10% using 3.0 wt %; by 6% using 1.5 wt %; and by 5% using 0.5 wt %. Also plotted in Table 6, water content of diluted-bitumen emulsion sample treated with composite absorbent particles, prepared according to Example 1, is reduced by 97% using 3.0 wt %; by 67% using 1.5 wt %; and by 24% using 0.5 wt %. Also plotted in Table 6, water content of diluted-bitumen emulsion sample treated with magnetic composite absorbent particles, prepared according to Example 8, is reduced by 93% using 3.0 wt %; by 64% using 1.5 wt %; and by 23% using 0.5 wt %.

TABLE 6
Amount of Emulsified Water Remaining in Emulsion Samples.

| | CMC + EC | CMC/EC #1 | CMC/EC #8 |
|---|---|---|---|
| 0.5 wt % | 84% | 69% | 75% |
| 1.0 wt % | 51% | 13% | 28% |
| 3.0 wt % | 4% | 3% | 6% |

### Example 15

A bitumen froth sample taken from a Denver Cell batch extraction with typical conditional containing 40 vol % entrained air is left undisturbed at ambient conditions for 24 h. Bitumen is removed from separated free water and diluted with heavy naphtha using a naphtha/bitumen ratio of 0.65 and placed in a mechanical shaker overnight at 200 cycles/min. The resulting diluted bitumen froth contains stable emulsified water droplets with average drop size less than 5 micrometers. This particular froth sample is known to be difficult to dewater using conventional methods including addition of demulsifier, dilution with solvent, and heating in a water bath. Water content of diluted bitumen froth is 5.5 wt %. Diluted bitumen froth samples were transferred into individual test tubes and treated with 1.0 wt % composite absorbent particles prepared according to Example 1 (CMC/EC #1 in Table 7), 1.0 wt % magnetic composite absorbent particles prepared according to Example 8 (CMC/EC #8 in Table 7), or 1.0 wt % CMC particles coated with EC by solvent evaporation prepared according to Example 11 (CMC+EC in Table 7). Treated diluted bitumen froth samples were placed in a mechanical shaker for 2 hours or placed in a vortex mixer for 30 seconds; followed by 1 hour of gravity settling in vertical position for samples treated with composite absorbent particles prepared according to Example 1 and samples treated with CMC particles coated with EC by solvent evaporation prepared according to Example 11 or 1 hour of magnetic separation for samples treated with magnetic composite absorbent particles prepared according to Example 8. As shown in Table 7, the amount of emulsified water remaining in diluted-bitumen froth samples treated with CMC particles coated with EC by solvent evaporation, prepared according to Example 11, is reduced by 6% after 30 seconds in vortex mixer followed by 1 hour of gravity settling in vertical position but is reduced by 35% after 2 hours in mechanical shaker followed by 1 hour of gravity settling in vertical position. As shown in Table 7, the amount of emulsified water remaining in diluted-bitumen froth samples treated with composite absorbent particles, prepared according to Example 1, is reduced by 55% after 30 seconds in vortex mixer followed by 1 hour of gravity settling in vertical position but is reduced by 63% after 2 hours in mechanical shaker followed by 1 hour of gravity settling in vertical position. As shown in Table 7, the amount of emulsified water remaining in diluted-bitumen froth samples treated with magnetic composite absorbent particles, prepared according to Example 8, is reduced by 56% after 30 seconds in vortex mixer followed by 1 hour of gravity settling in vertical position but is reduced by 57% after 2 hours in mechanical shaker followed by 1 hour of magnetic separation using a permanent magnet. After absorbing emulsified water, aggregates of composite absorbent particles are separated from the emulsion by filtration and washed with toluene. The wash solution is collected and placed in a rotary evaporator at 90° C. under reduced pressure to remove solvent; the amount of bitumen entrained in aggregates of composite absorbent particles is determine gravimetrically. Absorbed water is removed from aggregates of composite absorbent particles by washing with acetone. The wash solution is collected and placed in a rotary evaporator at 50° C. under reduced pressure to remove solvent; the amount of bitumen entrained in aggregates of composite absorbent particles is determine gravimetrically.

TABLE 7
Amount of Emulsified Water Remaining in Emulsion Samples

| | | 1.0 wt % | 1.0 wt % | 1.0 wt % |
|---|---|---|---|---|
| | BLK | CMC + EC | CMC/EC #1 | CMC/EC #8 |
| 30 s in vortex mixer | 98% | 94% | 45% | 44% |
| 2 h in a mechanical | 96% | 65% | 37% | 43% |
| shaker | | | | |

I claim:

1. A composition for drying an emulsion with a non-aqueous continuous phase comprising:
a) an absorbent material and
b) an interfacially active material;
wherein the absorbent material and the interfacially active material together form individual composite absorbent particles.

2. The composition of claim 1 wherein the emulsion is a petroleum emulsion, a bitumen emulsion, bitumen froth, diluted bitumen froth, or invert drilling fluid.

3. The composition of claim 1 wherein the absorbent material is coated by the interfacially active material.

4. The composition of claim 1 wherein the interfacially active material essentially covers the surface of the composite absorbent particles.

5. The composition of claim 1 wherein the surface of the composite absorbent particles is water-permeable.

6. The composition of claim 1 wherein the composite absorbent particles are capable of absorbing emulsified water.

7. The composition of claim 1 wherein the individual composite absorbent particles before absorbing water are lesser than 1000 micrometers and greater than 0.5 micrometers.

8. The composition of claim 1 wherein the composite absorbent particles after absorbing water form aggregates greater than 1 millimeter in a non-polar solvent.

9. The composition of claim 1 wherein:
the surface of composite absorbent particles is in a first state before absorbing water; and
the surface of composite absorbent particles is in a second state after absorbing water.

10. The composition of claim 9 wherein:
the composite absorbent particles are of intermediate wettability in the first state; and
the composite absorbent particles are hydrophilic in the second state.

11. The composition of claim 10 wherein:
the composite absorbent particles disperse in a non-polar solvent in the first state; and
the composite absorbent particles aggregate in the non-polar solvent in the second state.

12. The composition of claim 1 wherein the absorbent material comprises:
sodium carboxymethyl cellulose, starch, sodium polyacrylate, and poly(vinyl alcohol).

13. The composition of claim 1 wherein the interfacially active material comprises an emulsifier which stabilizes emulsions with non-aqueous continuous phase.

14. The composition of claim 13 wherein the interfacially active material comprises:
ethylcellulose, methylcellulose, and hydroxypropyl cellulose.

15. The composition of claim 1 wherein the composite absorbent particles further comprises a magnetic material.

16. A process for preparing the composite absorbent particles of claim 1 comprising:
a) the step of preparing an aqueous phase comprising the absorbent material,
b) the step of preparing a non-aqueous phase comprising the interfacially active material,
c) the step of emulsifying the aqueous phase and the non-aqueous phase into a precursor emulsion, and
d) the step of dehydrating the precursor emulsion;
wherein the aqueous phase is the dispersed phase of the precursor emulsion and the non-aqueous phase of the emulsion is the continuous phase of the precursor emulsion.

17. The process of claim 16 wherein the non-aqueous phase and aqueous phase together form a heterogeneous azeotrope and the step of dehydrating the precursor emulsion is by evaporation of the heterogeneous azeotrope.

18. The process of claim 16 wherein the non-aqueous phase further comprises:
a surfactant and a viscosity modifier.

19. The process of claim 16 wherein the aqueous phase further comprises:
a dissolved salt, a surfactant, a viscosity modifier, and a finely dispersed solid.

20. The process of claim 16 further comprises the step of chemical crosslinking or thermal crosslinking.

21. A process for removing emulsified water from an emulsion comprising:
a) the step of adding the composition of claim 1 to the emulsion;
b) the step of providing sufficient agitation and time for absorption the emulsified water by the composite absorbent particles; and
c) the step of separating the composite absorbent particles after absorption of water.

22. The process of claim 21 wherein the step of separating the composite absorbent particles after absorbing water comprises filtration or magnetic separation.
